(19) United States
(12) Patent Application Publication
(10) Pub. No.: US 2026/0219640 A1
(43) Pub. Date: Jul. 30, 2026

(54) REINFORCEMENT LEARNING INFORMED CONTROL OF NONLINEAR SYSTEMS WITH APPLICATIONS IN HYDROCARBON EXTRACTION

(71) Applicant: Sensia Netherlands B.V., Rotterdam (NL)

(72) Inventors: Aquib Mustafa, Houston, TX (US); Jonathan Wun Shiung Chong, Calgary (CA)

(73) Assignee: Sensia Netherlands B.V., Rotterdam (NL)

(21) Appl. No.: 19/456,315

(22) Filed: Jan. 22, 2026

Related U.S. Application Data
(60) Provisional application No. 63/749,467, filed on Jan. 24, 2025.
(60) Provisional application No. 63/890,068, filed on Sep. 29, 2025.

(51) Int. Cl. G05B 13/02; G06N 3/092

(52) U.S. Cl. CPC G05B 13/027; G06N 3/092

(57) ABSTRACT

Systems and methods for hydrocarbon extraction. The controller first calculates a weighting parameter that depends on the distance between the current operating point and a boundary of a desired operating region. The weighting parameter is used to train a reinforcement learning algorithm based on a trade-off between performance and operating within the desired operating region. The reinforcement learning algorithm generates a nominal control action which is corrected by a quadratic programming optimizer configured to adjust the nominal control action a minimal amount while ensuring that the operating point remains in the desired operating region. During operating changes the constraints forcing the control into the desired operating region may become infeasible and the reinforcement learning algorithm is configured to drive the operating point towards the desired operating region by way of the nominal control action.

### CROSS-REFERENCE TO RELATED PATENT APPLICATIONS

This application claims priority to and the benefit of U.S. Patent Application No. 63/749,467, filed Jan. 24, 2025 and U.S. Patent Application No. 63/890,068, filed Sep. 29, 2025, both of which are incorporated herein by reference in their entirety.

### BACKGROUND

The present disclosure relates to hydrocarbon sites. More specifically, the present disclosure relates to control of hydrocarbon sites including but not limited to control systems using edge devices in industrial systems, such as gas and oil extraction stations. Linear rod pumps or submersible pumps are driven by electric motors. Controllers send control signals (e.g., speed requests, voltage levels, etc.) to a motor drive, compressors, pumps, choke valves or other actuator to extract oil or other hydrocarbons.

### SUMMARY

An embodiment of the present disclosure relates to a system for controlling a hydrocarbon extraction site. The system includes one or more processing circuits configured to calculate a bounding parameter based on a distance between an operating point and a boundary of a desired operating region. The one or more processing circuits are also configured to generate a nominal control action for the hydrocarbon extraction site based on a reinforcement learning model. The one or more processing circuits are also configured to generate one or more operating constraints based on the bounding parameter. The one or more processing circuits are also configured to determine an implemented control action that (i) satisfies the one or more operating constraints and (ii) is based on the nominal control action, wherein the hydrocarbon extraction site is operated in accordance with the implemented control action.

In some embodiments, the one or more processing circuits are configured to determine the implemented control action by determining implemented parameters for a control algorithm configured to cause the implemented control action to satisfy the one or more operating constraints and calculating the implemented control action according to the control algorithm using the implemented parameters.

In some embodiments, the one or more processing circuits are configured to generate the nominal control action based on the reinforcement learning model by generating nominal parameters for a control algorithm according to the reinforcement learning model and calculating the nominal control action according to the control algorithm using the nominal parameters.

In some embodiments, the operating point includes at least one of a current of a motor, a choke position of a valve, an effective flow coefficient of the valve, a voltage of the motor, a frequency of an electrical signal applied to the motor, a speed of the motor, a fluid pressure, a fluid flow, a fluid temperature, or a relay state.

In some embodiments, wherein the reinforcement learning model is trained with a reward function including a performance term and a penalty term.

In some embodiments, a weight of the performance term and a weight of the penalty term are based on the bounding parameter.

In some embodiments, the weight of the performance term is a nonincreasing function of the bounding parameter and the weight of the penalty term is a nondecreasing function of the bounding parameter.

In some embodiments, the one or more processing circuits are configured to determine whether the one or more operating constraints are infeasible, and wherein the hydrocarbon extraction site is operated in accordance with the nominal control action responsive to a determination that the one or more operating constraints are infeasible.

In some embodiments, the one or more processing circuits are configured to determine the implemented control action by calculating a distance between a candidate control action and the nominal control action and selecting the candidate control action based on the distance.

Another embodiment of the present disclosure relates to a system for controlling a hydrocarbon extraction site. The system includes one or more processing circuits configured to calculate a bounding parameter based on a distance between an operating point and a boundary of a desired operating region. The one or more processing circuits are also configured to generate, using a machine learning model, one or more nominal control parameters for a control algorithm configured to control a variable of the hydrocarbon extraction site according to a setpoint. The one or more processing circuits are also configured to generate one or more operating constraints for one or more implemented control parameters based on the bounding parameter, the one or more operating constraints configured to constrain a control action generated according to the control algorithm using the one or more implemented control parameters to maintain the variable within the desired operating region. The one or more processing circuits are also configured to determine the one or more implemented control parameters that (i) satisfy the one or more operating constraints and (ii) are based on the one or more nominal control parameters, wherein the hydrocarbon extraction site is operated in accordance with the one or more implemented control parameters.

In some embodiments, the one or more processing circuits are configured to communicate the implemented control parameters to a second device configured to generate an implemented control action based on the one or more implemented control parameters to operate the hydrocarbon extraction site in accordance with the control algorithm using the one or more implemented control parameters.

In some embodiments, the operating point includes at least one of a current of a motor, a choke position of a valve, an effective flow coefficient of the valve, a voltage of the motor, a frequency of an electrical signal applied to the motor, a speed of the motor, a fluid pressure, a fluid flow, a fluid temperature, or a relay state.

In some embodiments, the machine learning model is a reinforcement learning model trained with a reward function including a performance term and a penalty term.

In some embodiments, a weight of the performance term is a nonincreasing function of the bounding parameter and a weight of the penalty term is a nondecreasing function of the bounding parameter.

In some embodiments, the one or more processing circuits are configured to determine whether the one or more operating constraints are infeasible, and wherein the hydrocarbon extraction site is operated in accordance with the one or more nominal control parameters responsive to a determination that the one or more operating constraints are infeasible.

In some embodiments, the one or more processing circuits are configured to determine the one or more implemented control parameters by calculating a distance between candidates for the one or more implemented control parameters and the one or more nominal control parameters and selecting the one or more implemented control parameters from the candidates based on the distance.

Another embodiment relates to a system for controlling a hydrocarbon extraction site. The system includes one or more processing circuits configured to calculate a bounding parameter based on a distance between an operating point and a boundary of a desired operating region. The one or more processing circuits are also configured to generate, using a reinforcement learning model, one or more nominal control parameters for a control algorithm configured to control a variable of the hydrocarbon extraction site according to a setpoint. The one or more processing circuits are also configured to generate a nominal control action by executing the control algorithm using the one or more nominal control parameters. The one or more processing circuits are also configured to generate one or more operating constraints for an implemented control action based on the bounding parameter, the one or more operating constraints configured to constrain the implemented control action to maintain the variable within the desired operating region. The one or more processing circuits are also configured to determine the implemented control action that (i) satisfies the one or more operating constraints and (ii) is based on the nominal control action, wherein the hydrocarbon extraction site is operated in accordance with the implemented control action.

In some embodiments, the one or more processing circuits are disposed on a first device and a second device. The first device is configured to generate the one or more nominal control parameters and the one or more operating constraints. The second device is configured to determine the implemented control action that (i) satisfies the one or more operating constraints and (ii) is based on the nominal control action, and operate the hydrocarbon extraction site in accordance with the implemented control action.

In some embodiments, the first device is a server device and the second device is an edge device.

In some embodiments, the reinforcement learning model is trained with a reward function including a performance term and a penalty term.

### BRIEF DESCRIPTION OF THE DRAWINGS

FIG. 1 is a perspective view of a hydrocarbon site equipped with well devices, according to some embodiments.

FIG. 2 is a schematic diagram of a well site that includes a pump, according to some embodiments.

FIG. 3 is a schematic block diagram of a site control system using reinforcement learning informed control, according to some embodiments.

FIG. 4A is a signal flow diagram of a site control system using reinforcement learning informed control, according to some embodiments.

FIG. 4B is another signal flow diagram of a site control system using reinforcement learning informed control, according to some embodiments.

FIG. 4C is another signal flow diagram of a site control system using reinforcement learning informed control, according to some embodiments.

FIG. 5 is a flow of operations for site control using control barrier functions and reinforcement learning, according to some embodiments.

FIG. 6A is a plot of experimental results for the control system of FIG. 3 using a fixed bounding parameter, according to some embodiments.

FIG. 6B is a plot of experimental results for the control system of FIG. 3 using a dynamic bounding parameter, according to some embodiments.

FIG. 7A is a plot of experimental results for the control system of FIG. 3 during a first time period when a constraint is changed during operation, according to some embodiments.

FIG. 7B is a plot of experimental results for the control system of FIG. 3 during a second time period after a constraint is changed during operation, according to some embodiments.

FIG. 7C is a plot of experimental results for the control system of FIG. 3 during a third time period after a constraint is changed during operation, according to some embodiments.

FIG. 8A is a plot of experimental results for the control system of FIG. 3 comparing proportional integral derivative (PID) control to reinforcement learning informed control, according to some embodiments.

FIG. 8B is a plot of experimental results for the control system of FIG. 3 illustrating the behavior during setpoint changes, according to some embodiments.

FIG. 8C is a plot of experimental results for the control system of FIG. 3 illustrating a switch from static PID control to PID control informed by reinforcement learning, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to control systems at hydrocarbon extraction sites. For example, control systems may provide control of motors used to drive pump systems including, but not limited to, electric submersible pumps, progressive cavity pumps, linear rod pumps, or any other type of pump applied to pumping hydrocarbons from well reservoirs. Control systems may also control choke valves and/or injection equipment used to affect the flow and/or pressure of extracted hydrocarbons. Systems and methods are used to cause the motor and/or well site to operate at a high or improved efficiency, while ensuring the motor, pumping system, and/or other control elements remain in a desired operating region (e.g., a stable or controlled combination of motor current, motor voltage, pump pressure, fluid flow, etc.) away from operating points where adverse conditions (e.g., erosion, hydrate formation, etc.) can occur. While the systems and methods disclosed can be used for any system, they are particularly advantageous in the hydrocarbon industry in which well site optimization can provide large monetary savings, but stability of control and pump uptime may be of equal or greater importance.

Conventional systems may not use reinforcement learning control because of the inability for such a controller to guarantee that the system remains within a desired operating region, especially in the presence of disturbances, model inaccuracies, and/or nonlinearities. The systems and methods herein use constraints provided by a control barrier function to adjust the output of a reinforcement learning control system (e.g., optimizer, controller, etc.) to maintain the system within the desired operating region. Advantageously, a bounding parameter of the control barrier function is implemented dynamically, allowing the system to tighten or loosen the constraints as the system nears the boundary of the desired operating region. Additionally, the dynamic bounding parameter may be used by the reinforcement learning controller in the reward function for learning appropriate control actions, whereby actions moving the control near the boundary of the desired operating region may be rewarded according to a penalty function, whereas other actions (e.g., at the interior of the desired operating region) are rewarded according to the performance (e.g., efficiency, hydrocarbon extraction rate, etc.) of the system. The reinforcement learning system may learn to operate in the interior of the desired operating region, requiring fewer adjustments based on the constraints. Additionally, the reinforcement learning system may be used to recover control or move to a new operating region as conditions change or additional constraints are added that cause the control barrier-based constraints to become infeasible.

In some embodiments, the reinforcement learning system provides parameters for a controller. For example, the reinforcement learning system may provide parameters to a local controller (e.g., edge device, etc.) executing a feedback-based control algorithm such as proportional-integral-derivative (PID) control. Advantageously, the systems and methods described herein can facilitate integration of reinforcement learning into existing control systems without replacing controllers. In some embodiments, the constraints from the control barrier function are used to ensure that the parameters provided to the local controller will cause operation to remain in the desired operating region. In some embodiments, the parameters generated by the reinforcement learning system are provided to the local controller with constraints for the control action. The local controller may calculate the control action based on the parameters received and then constrain the action using the constraints.

### Hydrocarbon Site Overview

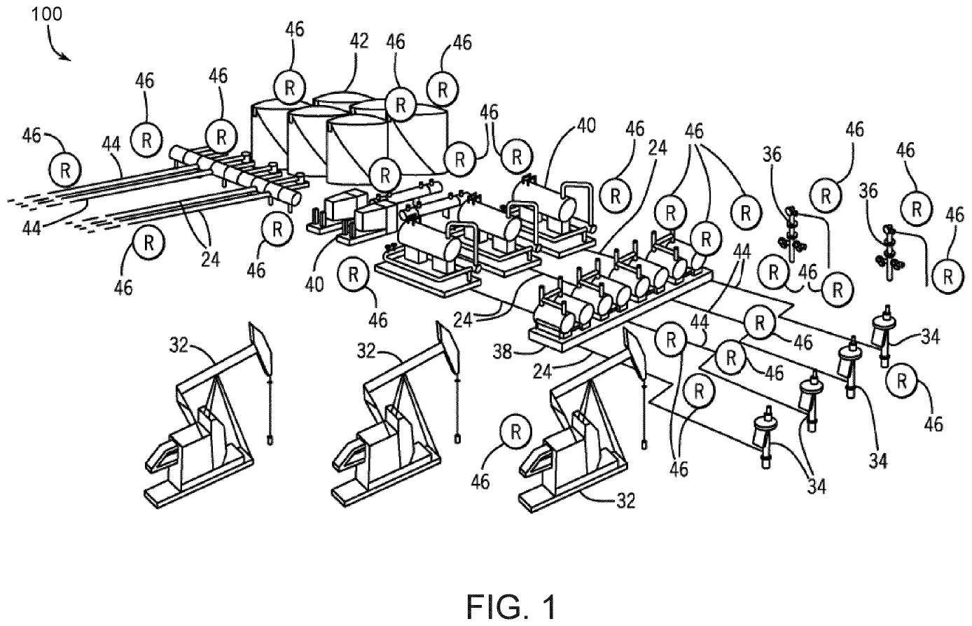

Referring now to FIG. 1, a hydrocarbon site 100 may be an area in which hydrocarbons, such as crude oil and natural gas, may be extracted from the ground, processed, and/or stored. As such, the hydrocarbon site 100 may include a number of wells and a number of well devices that may control the flow of hydrocarbons being extracted from the wells. In one embodiment, the well devices at the hydrocarbon site 100 may include any device equipped to monitor and/or control production of hydrocarbons at a well site. As such, the well devices may include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons may be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 may be connected together via a network of pipelines 44. As such, hydrocarbons extracted from a reservoir may be transported to various locations at the hydrocarbon site 100 via the network of pipelines 44.

The pumpjack 32 may mechanically lift hydrocarbons (e.g., oil) out of a well when a bottom hole pressure of the well is not sufficient to extract the hydrocarbons to the surface. The submersible pump 34 may be an assembly that may be submerged in a hydrocarbon liquid that may be pumped. As such, the submersible pump 34 may include a hermetically sealed motor, such that liquids may not penetrate the seal into the motor. Further, the hermetically sealed motor may push hydrocarbons from underground areas or the reservoir to the surface.

The well trees 36 (e.g., christmas trees) may be an assembly of valves, spools, and fittings used for natural flowing wells. As such, the well trees 36 may be used for an oil well, gas well, water injection well, water disposal well, gas injection well, condensate well, and the like. The wellhead distribution manifolds 38 may collect the hydrocarbons that may have been extracted by the pumpjacks 32, the submersible pumps 34, and the well trees 36, such that the collected hydrocarbons may be routed to various hydrocarbon processing or storage areas in the hydrocarbon site 100.

The separator 40 may include a pressure vessel that may separate well fluids produced from oil and gas wells into separate gas and liquid components. For example, the separator 40 may separate hydrocarbons extracted by the pumpjacks 32, the submersible pumps 34, or the well trees 36 into oil components, gas components, and water components. After the hydrocarbons have been separated, each separated component may be stored in a particular storage tank 42. The hydrocarbons stored in the storage tanks 42 may be transported via the pipelines 44 to transport vehicles, refineries, and the like.

The well devices may also include monitoring systems that may be placed at various locations in the hydrocarbon site 100 to monitor or provide information related to certain aspects of the hydrocarbon site 100. As such, the monitoring system may be a controller, a remote terminal unit (RTU), or any computing device that may include communication abilities, processing abilities, and the like. For discussion purposes, the monitoring system will be embodied as the RTU 46 throughout the present disclosure. However, it should be understood that the RTU 46 may be any component capable of monitoring and/or controlling various components at the hydrocarbon site 100. The RTU 46 may include sensors or may be coupled to various sensors that may monitor various properties associated with a component at the hydrocarbon site 100.

The RTU 46 may then analyze the various properties associated with the component and may control various operational parameters of the component. For example, the RTU 46 may measure a pressure or a differential pressure of a well or a component (e.g., storage tank 42) in the hydrocarbon site 100. The RTU 46 may also measure a temperature of contents stored inside a component in the hydrocarbon site 100, an amount of hydrocarbons being processed or extracted by components in the hydrocarbon site 100, and the like. The RTU 46 may also measure a level or amount of hydrocarbons stored in a component, such as the storage tank 42. In certain embodiments, the RTU 46 may be iSens-GP Pressure Transmitter, iSens-DP Differential Pressure Transmitter, iSens-MV Multivariable Transmitter, iSens-T2 Temperature Transmitter, iSens-L Level Transmitter, or Isens-1O Flexible 1/0 Transmitter manufactured by vMonitor® of Houston, Texas.

In one embodiment, the RTU 46 may include a sensor that may measure pressure, temperature, fill level, flow rates, and the like. The RTU 46 may also include a transmitter, such as a radio wave transmitter, that may transmit data acquired by the sensor via an antenna or the like. The sensor in the RTU 46 may be a wireless sensor that may be capable of receiving and sending data signals between RTUs 46. To power the sensors and the transmitters, the RTU 46 may include a battery or may be coupled to a continuous power supply. Since the RTU 46 may be installed in harsh outdoor and/or explosion-hazardous environments, the RTU 46 may be enclosed in an explosion-proof container that may meet certain standards established by the National Electrical Manufacturer Association (NEMA) and the like, such as a NEMA 4X container, a NEMA 7X container, and the like.

The RTU 46 may transmit data acquired by the sensor or data processed by a processor to other monitoring systems, a router device, a supervisory control and data acquisition (SCADA) device, or the like. As such, the RTU 46 may enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 may receive real-time or near real-time data associated with a well device. The data may include, for example, tubing head pressure, tubing head temperature, case head pressure, flowline pressure, wellhead pressure, wellhead temperature, and the like. In any case, the RTU 46 may analyze the real-time data with respect to static data that may be stored in a memory of the RTU 46. The static data may include a well depth, a tubing length, a tubing size, a choke size, a reservoir pressure, a bottom hole temperature, well test data, fluid properties of the hydrocarbons being extracted, and the like. The RTU 46 may also analyze the real-time data with respect to other data acquired by various types of instruments (e.g., water cut meter, multiphase meter) to determine an inflow performance relationship (IPR) curve, a desired operating point for the wellhead 30, key performance indicators (KPIs) associated with the wellhead 30, wellhead performance summary reports, and the like. Although the RTU 46 may be capable of performing the above-referenced analyses, the RTU 46 may not be capable of performing the analyses in a timely manner. Moreover, by just relying on the processor capabilities of the RTU 46, the RTU 46 is limited in the amount and types of analyses that it may perform. Moreover, since the RTU 46 may be limited in size, the data storage abilities may also be limited.

In certain embodiments, the RTU 46 may establish a communication link with the cloud-based computing system 12 described above. As such, the cloud-based computing system 12 may use its larger processing capabilities to analyze data acquired by multiple RTUs 46. Moreover, the cloud-based computing system 12 may access historical data associated with the respective RTU 46, data associated with well devices associated with the respective RTU 46, data associated with the hydrocarbon site 100 associated with the respective RTU 46, and the like to further analyze the data acquired by the RTU 46. The cloud-based computing system 12 is in communication with the RTU 46 via one or more servers or networks (e.g., the Internet).

In some embodiments, the best operating point of a submersible downhole pump may be determined by performing an optimization process. For example, model-based optimization or artificial intelligence may be used in order to determine an operating point (i.e., operating pressure, flow, and/or speed of the pump). In some embodiments, the optimization process may include determining the set of wells and the corresponding pump operating points in order to hit a certain production constraint while operating efficiently. In some embodiments, the best operating point may be transmitted to a motor optimization system.

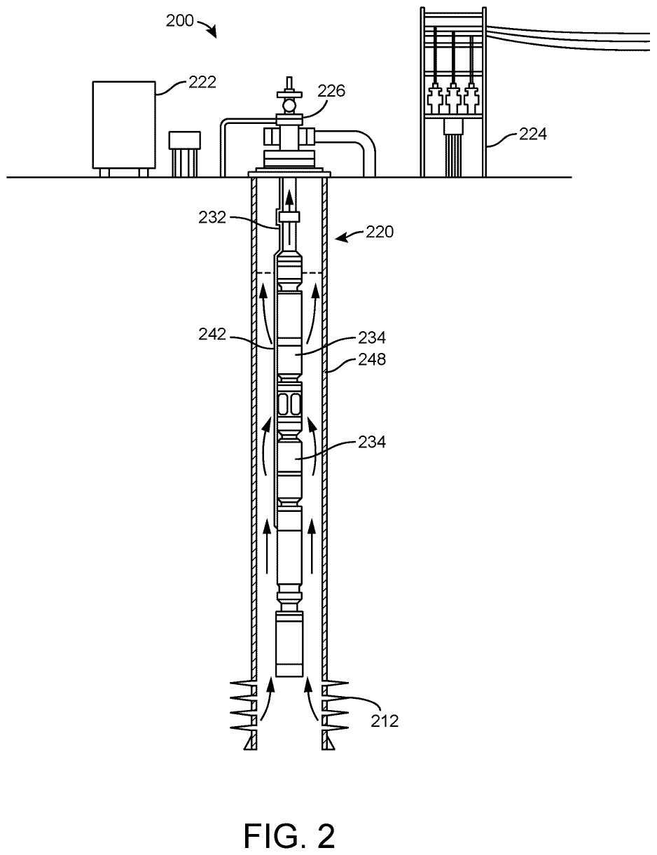

With reference to FIG. 2, a well site 200 includes a pump 220, a controller 222, electrical transformers 224, and a well head 226. Produced fluids 212 are pumped by pump 220 to well head 226. Pump 220 can be one or more electrical submersible pumps (ESPs), each including an electric motor controlled by a variable speed drive (VSD) in controller 222. The variable speed drive adjusts output of pump 220 by controlling the speed of the electric motor via signals to the armature, rotor/stator, or other winding of the motor. The motors are two pole, three phase induction motors in some embodiments. Controller 222 can also include a user interface (UI) or a computer to provide various settings for well site operations. Although shown as a subsurface pump, pump 220 can be any type of pump or motor system in some embodiments.

Electrical transformers 224 provide power (e.g., electric voltage and current for the variable speed drive). Controller 222 includes circuits and components that can protect components of well site 200 by shutting off power if normal operating limits are not maintained. Power cables 232 supply the electric signals to one or more motors through armor protected, insulated conductors. Power cables 232 are round except for a flat section along the one or more ESPS and motor protectors where space is limited in some embodiments. In some embodiments, the motor protectors connect pump 220 to the motor and isolate the motor from produced fluids and other well fluids. The motor protectors serve as an oil reservoir and equalize pressure between the well bore and the well casing or tubing casing annulus 248 and allow expansion and/or contraction of motor oil in some embodiments.

Pump housing 234 for pump 220 includes multi-stage rotating impellers and stationary diffusers in some embodiments. The number of stages (e.g., centrifugal stages) is related to the rate, pressure, and required power and can be any number from 1 to n depending on design criteria and well site parameters. Gas separators 242 can be employed to segregate some free gas from produced fluids into the tubing casing annulus 248 by fluid reversal or rotary centrifuge before gas enters pump 220. Intakes to pump 220 allow fluids to enter the pump 220 and may be part of a gas separator 242. In some embodiments, the well site 200 is for a cased well or an open well. For example, a partially cased well may include an open well portion or portions. An annular space may exist between an outer surface of tubing casing annulus 248 and the pump 220.

The present disclosure relates to pump systems, including, but not limited to, downhole pump systems, reciprocating pump systems such as sucker rod pump systems, submersible pump systems, electric motors on a well site, and other electrical systems. In some embodiments, isolation is achieved for measuring and/or data acquisition devices. In some embodiments, the systems and methods avoid potentially destructive saturation effects on coupling transformers with direct current (DC) contents and/or high voltage to frequency (volts/hertz (V/Hz)) ratios. The systems and methods allow better assessment of developing cable or motor leakage to ground through the zero-sequence voltage for quantified symmetry to ground (e.g., earth) of the phase voltages.

In some embodiments, the systems and methods of isolation allow more types of measurements and more precise measurements with less cost and no saturation risk related to high V/Hz ratios or DC contents. An apparatus provides a cost-effective solution for proper high voltage insulation with no or little performance degradation on the analog acquisition.

With reference to FIG. 2, a well site 200 includes a pump 220, a controller 222, electrical transformers 224, and a well head 226. Produced fluids 212 are pumped by pump 220 to well head 226. Pump 220 can be one or more electrical submersible pumps (ESPs), each including an electric motor controlled by a variable speed drive in controller 222. The variable speed drive adjusts the output of pump 220 by controlling the speed of the electric motor via signals to the armature, rotor/stator, or other winding of the motor. The motors are two pole, three phase induction motors in some embodiments. Controller 222 can also include a user interface or a computer to provide various settings for well site operations. Although shown as a subsurface pump, pump 220 can be any type of pump or motor system in some embodiments.

Electrical transformers 224 provide power (e.g., electric voltage and current for the variable speed drive). Controller 222 includes circuits and components that can protect components of well site 200 by shutting off power if normal operating limits are not maintained. Power cables 232 supply the electric signals to one or more motors through armor protected, insulated conductors. Power cables 232 are round except for a flat section along the one or more ESPS and motor protectors where space is limited in some embodiments. In some embodiments, the motor protectors connect pump 220 to the motor and isolate the motor from produced fluids and other well fluids. The motor protectors serve as an oil reservoir and equalize pressure between the well bore and the well casing or tubing casing annulus 248 and allow expansion and/or contraction of motor oil in some embodiments.

Pump housing 234 for pump 220 includes multi-stage rotating impellers and stationary diffusers in some embodiments. The number of stages (e.g., centrifugal stages) is related to the rate, pressure, and required power and can be any number from 1 to n depending on design criteria and well site parameters. Gas separators 242 can be employed to segregate some free gas from produced fluids into the tubing casing annulus 248 by fluid reversal or rotary centrifuge before gas enters pump 220. Intakes to pump 220 allow fluids to enter the pump 220 and may be part of a gas separator 242. In some embodiments, the well site 200 is for a cased well or an open well. For example, a partially cased well may include an open well portion or portions. An annular space may exist between an outer surface of tubing casing annulus 248 and the pump 220.

The controller 222 may execute control algorithms to determine a best operating point for the motor. The operating point may refer to a number of variables or conditions that define the operations of the motor and/or pump system. For example, the operating point may be represented by a vector in a vector space of the variables or conditions and may include the voltage provided by the VSD to the motor, the frequency of the electrical signal provided by the VSD to the motor, pressure the pump is pumping against, fluid flow of the pump, torque produced by the motor, rotational speed of the motor, operating temperature of the motor, and/or any other condition or variable that the controller 222 may require as input to a control algorithm or determine as part of the output. The controller 222 may obtain (e.g., acquire, receive, etc.) measurements from one or more sensors configured to measure the conditions or variables to determine an appropriate output or value of a control variable. The controller 222 may generate electric control signals and transmit them to other equipment of the well site 200 to cause the motor and pump system to operate at an expected or desired operating point.

The controller 222 may communicate a desired operating point by way of electric control signals to other equipment of the well site 200. Communication may be performed using digital control signals, analog control signals, or both. Digital control signals may be sent using a specific communication protocol and numeric representation (e.g., floating point, fixed point, text-based) that the equipment of the well site 200 can understand. Analog control signals may be used to communicate with or actuate the equipment at various levels. For example, the controller 222 may communicate a desired frequency of the electrical signal sent to the motor of the pump to the VSD (e.g., either internal to the controller 222 or external to the controller 222); the VSD may adjust the frequency or phase of timing signals transmitted to power transistors of the VSD to cause the output electrical signal to operate at the desired frequency. Measurements from sensors may also be obtained digitally (e.g., using a digital communication protocol) or by way of analog signals (e.g., a voltage that is proportional to the pump pressure, etc.).

In some embodiments, the controller 222 determines control actions based on the desired operating point. For example, the desired operating point may include one or more setpoints. The controller 222 may determine control actions (e.g., values) for other variables (e.g., actuation levels, relay states, etc.) in order to cause the operating point of the well site 200 to control towards the desired operating point. The controller 222 operates the well site equipment (e.g., the pump 220 or other equipment at the well site 200) according to the determined control action by communicating the control action to the equipment (e.g., the actuator of the equipment such as the VSD) for implementation.

### Adaptive Region-Based Constraint Management for Reinforcement Learning

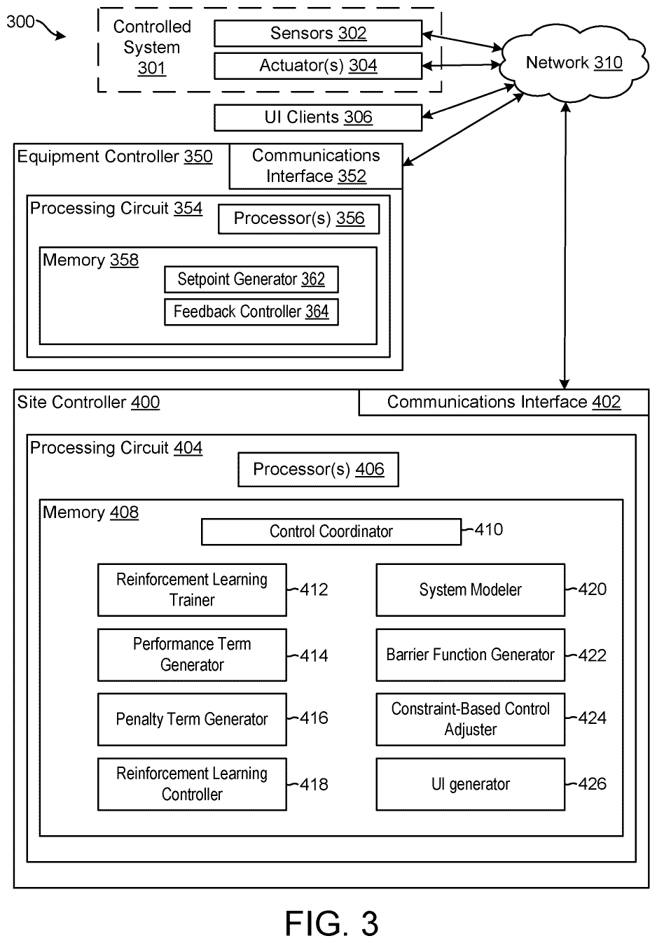

With reference to FIG. 3, a site control system 300 for a well site 200 or other motor control application may include a controlled system 301 having one or more sensors 302 and one or more actuators 304, one or more UI clients 306, and a site controller 400 communicably connected via a network 310. The operation of the site control system 300 is to use the one or more sensors 302 to determine the operating conditions of the motor; based on the measurements from the one or more sensors 302 to determine control values or a control signal using the site controller 400; and communicate those control values or the control signal to the one or more actuators 304 to drive the motor system to a desired operating point. In some embodiments, the controlled system 301 is a hydrocarbon or well site (e.g., the hydrocarbon site 100 or the well site 200). However, it is contemplated that the systems and methods described herein may be applicable in many control applications, for example, robotics, process automation, etc.

In some embodiments, the site control system 300 is configured to generate a nominal control action or nominal control parameters for a control algorithm that will in turn generate a control action. For example, the nominal control action or nominal control parameters may be generated using a reinforcement learning model or other machine learning model (e.g., transformer model, recursive neural network, feedforward network, etc.). The nominal control action or nominal control parameters may be provided to a constraint-based control adjustment algorithm, for example, that uses control barrier functions to ensure that control actions or control parameters used by downstream components will keep the operating conditions of the controlled system 301 within an operating region that having some desirable characteristics (e.g., stability, low overshoot, increased efficiency, etc.). Nominal control actions or nominal control parameters that satisfy the constraints may provided to the controlled system 301 as implemented control parameters or an implemented control action. Alternatively, nominal control actions or nominal control parameters that do not satisfy the constraints may modified to so that the constraints are satisfied before being provided the controlled system 301 as implemented control parameters or an implemented control action. For example, the site control system 300 may determine (e.g., calculate, select from candidate options, etc.) an implemented control action or implemented control parameters that are close to the respective nominal values, but are adjusted (e.g., modified, recalculated, etc.) to satisfy the constraints.

In some embodiments, the site control system 300 includes one or more equipment controllers 350. The equipment controllers 350 may provide local control for various equipment. For example, the one or more equipment controllers 350 may be used in addition to the site controller 400 (e.g., the site controller 400 may provide control parameters to the one or more equipment controllers 350, with the one or more equipment controllers 350 providing the control actions to the controlled system 301), or as an alternative to the site controller 400 (e.g., as a failsafe if the site controller 400 fails or loses network connection). In some embodiments, the site controller 400 provides control parameters that are optimized and/or based on a reinforcement learning model to improve the capability of the one or more equipment controllers 350. For example, the parameters provided to the one or more equipment controllers 350 may facilitate control with less deviation from setpoint, that is more robust to disturbances, and maintains the system within a certain region of a state space (e.g., within constraints), etc.

The site controller 400, by way of example, may be a component (e.g., a circuit, a printed circuit board, instruction set, etc.) of the controller 222. In some embodiments, the site controller 400 may be substantially similar to the controller 222 and can be used as an alternative to the controller 222 to provide the functionality of the controller 222 described previously. In some embodiments, the site controller 400 may be distributed across multiple devices (e.g., discrete hardware units). For example, a first portion of the site controller 400 may be implemented on a server device (e.g., computer, server, node within a cluster of computers, configured in a cloud architecture, etc.) and a second portion of the site controller 400 may be implemented as an edge device (e.g., component of the controller 222, local microcontroller, etc.). Calculations, determinations, etc. performed in the first portion may be communicated (e.g., via the network 310 or a separate network) to the second portion in the controller 222 for further processing and/or application to the one or more actuators 304.

The one or more equipment controllers 350 may be similarly configured as the site controller 400. For example, the one or more equipment controllers 350 may be a component (e.g., a circuit, a printed circuit board, instruction set, etc.) of the controller 222, may be the same as the controller 222, or may be substantially similar to the controller 222. In some embodiments, the one or more equipment controllers 350 may be distributed across multiple devices (e.g., discrete hardware units). The one or more equipment controllers 350 may also be implemented within a cluster of computers. For example, the one or more equipment controllers 350 may be implemented on the same cluster or the same node as the site controller 400. All or some of the functionality of the one or more equipment controllers 350 may also be implemented within the one or more equipment controllers 350. Similarly, some or all of the functionality of the site controller 400 may be included in the one or more equipment controllers 350. For example, the functionality of the one or more equipment controllers 350 and the site controller 400 may be implemented within the controller 222.

Although the network 310 is shown as a single network, it is understood that the network 310 may include multiple networks and/or buses. For example, the network 310 may include a network communicating using internet protocol (IP) and a second network for local communication between the one or more equipment controllers 350 and/or the site controller 400 and the one or more sensors 302 and the one or more actuators 304 of the controlled system 301. In addition, communication of information between some devices of the site control system 300 may not use the network 310. The one or more equipment controllers 350 and the site controller 400 may include direct connections to the one or more sensors 302 and/or the one or more actuators 304. For example, the one or more sensors 302 may provide analog signals over a wire and/or the one or more actuators 304 may accept analog values as input to drive their functionality.

The one or more sensors 302 may be configured to measure and collect data related to the operating variables or conditions of the motor and/or the devices driven by the motor (e.g., the pump 220). The one or more sensors 302 may communicate the data digitally over the network 310 to the site controller 400 or one or more equipment controllers 350 for processing. In some embodiments, one or more sensors 302 are connected directly to the site controller 400 or the one or more equipment controllers 350 and provide data by way of an analog signal, for example, proportional to the value of the operating variable or condition being measured. The one or more sensors 302 may collect data periodically and deliver the data to the site controller 400 or the one or more equipment controllers 350 on the same period and/or a different period. For example, the one or more sensors 302 may collect data at a shorter period (e.g., more often) than it is communicated to the site controller 400 or the one or more equipment controllers 350 to improve measurement statistics (e.g., noise, uncertainty, etc.) by filtering or averaging the measurements before communicating them to the site controller 400. In some embodiments, the measurements are communicated to the site controller 400 or the one or more equipment controllers 350 upon a change-of-value (COV). For example, the measurement may only be communicated after the value has changed by more than a certain amount since the last communicated value.

The one or more actuators 304 may be configured to receive control signals from the site controller 400 or the one or more equipment controllers 350 and cause a connected motor to operate at a certain operating point. The actuators may receive analog and/or digital control signals indicating the desired operation. The one or more actuators 304 may include a motor drive configured to generate electric power for the coils of the motor (e.g., the stator and/or rotor) at a specific frequency and/or voltage, and the one or more actuators 304 may also include other control devices. For example, the one or more actuators 304 may include a motor starter, relays of the starter, motor actuators (e.g., controlling vane position of pumps connected to the motor, choke valve openings, etc.), or any other device that can affect the operation of the motor.

An operating point may refer to a set of values that provide information related to the operation of a system (e.g., a motor, a well site, a hydrocarbon site, etc.). The values of an operating point may include measurements of the system from the one or more sensors 302, activation levels sent to the one or more actuators 304 and/or internal states of the system (e.g., that may be estimated from measurements and/or actuation levels). The operating point may, for example, be represented as a vector in the space where each dimension of the space is associated with one of the values related to the operation of the system. Nonlimiting examples of the values of the operating point (and dimensions of the space if represented as a vector) include a current of a motor; a choke position of a valve; an effective flow coefficient of the valve (e.g., defining the relationship between pressure and flow); a voltage of the motor; a frequency of an electrical signal applied to the motor; a speed of the motor; a fluid pressure; a fluid flow; a fluid temperature; or a relay state (e.g., open or closed, activated or inactive, etc.). In some embodiments, operating point is used similarly to the state of a system formulated in the state-space framework, but may also include the measurements and/or the control actions (e.g., actuator inputs or actuation levels). In some embodiments, the site control system 300 is configured to maintain the operating point within a permissible set of operating points (e.g., a region, etc.) that have desirable characteristics (e.g., an acceptable amount of overshoot during a setpoint change, rapid disturbance rejection, etc.).

The one or more UI clients 306 may be configured to provide a UI, for example, based on instructions received from the site controller 400. An operator may use the one or more UI clients 306 in order to configure the site controller 400. For example, the UI may provide buttons, selection boxes, and/or text entry fields to allow the operator to configure the site controller 400 for a particular model number of a motor, a particular application, etc. Additionally or alternatively, a developer or administrator may use the one or more UI clients 306 in order to deploy new versions of software or firmware to the site controller 400. In some embodiments, read-only screens may also be generated from instructions from the site controller 400 communicated to the one or more UI clients 306. Read-only screens may provide executive views of data including savings attributed to advanced control algorithms provided by the site controller 400 and/or downtime avoided by such advanced control algorithms.

To produce the UI, the one or more UI clients 306 may use a preinstalled proprietary application configured to interpret the instructions from the site controller 400. Additionally or alternatively, the one or more UI clients 306 may use a standard application (e.g., an internet browser) and the instructions can be provided to the one or more UI clients 306 in the form of JavaScript and/or Cascading Style Sheets (CSS).

The network 310 can include routers, switches, antennas, computers, and any other hardware required to communicate information between the components of the site control system 300 (e.g., from the one or more sensors 302 to the site controller 400). A portion of the network 310 can be wireless and/or a portion of the network 310 can be wired. The network 310 can include one or more networks with routers to facilitate data transfer between the different networks. For example, the network 310 may include an external network to communicate to the one or more UI clients 306 and allow remote deployment and configuration and the network 310 may include an internal network to provide secure communication between the one or more sensors 302, the site controller 400, and the one or more actuators 304.

The site controller 400 is shown to include a communications interface 402 and one or more processing circuits 404. The communications interface 402 may be configured to communicate with other devices of the site control system 300 over the network 310. The communications interface 402 may generate electronic control signals configured to be transmitted over the network 310 or directly to the controlled system 301. The electronic control signals may encode information to cause the controlled system 301 to operate in a desirable way (e.g., following a setpoint, remaining within the permissible set, or according to the decisions of the one or more equipment controllers 350 or the site controller 400). For example, the electronic control signals may encode actuator values such as positions, relay states, drive frequencies, etc., and/or control parameters such as gains for a proportional integral derivative (PID) controller. The one or more processing circuits 404 may be configured to execute the operations and/or calculations of the control algorithms utilized by the site control system 300. The one or more processing circuits 404 are shown to include one or more processors 406 communicably coupled to memory 408. The memory 408 is configured with instructions that when executed by the one or more processors 406 cause the one or more processors 406 to perform operations. For example, the operations may include the calculations of the control algorithms, the generation of the control signals, and/or any other operation of the site controller 400.

The one or more processors 406 may be a general-purpose or specific-purpose processors, an application-specific integrated circuit (ASIC), one or more field-programmable gate arrays (FPGAs), a group of processing components, or other suitable processing components. The one or more processors 406 may be configured to execute computer code and/or instructions stored in the memories or received from other computer-readable media (e.g., CD-ROM, network storage, a remote server, etc.). The one or more processors 406 may be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memory 408 may include one or more devices (e.g., memory units, memory devices, storage devices, etc.) for storing data and/or computer code for completing and/or facilitating the various processes described in the present disclosure. The memory 408 may include random access memory (RAM), read-only memory (ROM), hard drive storage, temporary storage, non-volatile memory, flash memory, optical memory, or any other suitable memory for storing software objects and/or computer instructions. The memory 408 may include database components, object code components, script components, or any other type of information structure for supporting the various activities and information structures described in the present disclosure. The memory 408 may be communicably connected to the processors and can include computer code for executing (e.g., by the processors) one or more processes described herein.

The one or more equipment controllers 350 are shown to have a similar configuration, including a communications interface 352, a processing circuit 354, one or more processors 356, and memory 358. Each of these components of the one or more equipment controllers 350 may have a configuration described as a possible configuration of the respective component of the site controller 400. It is noted that the one or more equipment controllers 350 and the site controller 400 may not have the same configuration. For example, the site controller 400 may be implemented in a computer cluster or a local computer network, whereas the one or more equipment controllers 350 may be implemented on an edge controller (e.g., using a microcontroller).

The memory 358 of the one or more equipment controllers 350 is shown to include instruction sets (e.g., circuits, functionality, code, etc.) used to perform control of the equipment in the controlled system 301. The memory 358 may include a setpoint generator 362 and a feedback controller 364.

In some embodiments, the setpoint generator 362 generates a setpoint for the feedback controller 364. The setpoint may represent a desired value for one or more states or measurements from the network 310. In some embodiments, the setpoint is a value related to the production of hydrocarbons from a well or well site 200. For example, the setpoint may include flow, throttle angle, pump pressure, etc. The setpoint generator 362 may be configured to generate the setpoint based on various information related to the controlled system 301. For example, the setpoint may be based on demand for the hydrocarbons, availability of transportation for the hydrocarbons, or any other variable that would affect the desired amount of production. In some embodiments, the setpoint generator 362 is configured to perform an optimization in order to determine an appropriate setpoint (e.g., with constraints and/or an objective function based on the variables described herein).

The feedback controller 364 may be configured to process sensor information received from the one or more sensors 302 and generate commands for the one or more actuators 304 based on the sensor information. The feedback controller 364 may implement a feedback control algorithm, for example, to control one or more states according to a setpoint provided by the setpoint generator 362. The feedback controller 364 may be configured to generate commands for the one or more actuators 304 to maintain (e.g., control, etc.) the one or more states near their respective setpoints even in the presence of disturbances such as noise or environmental effects. The feedback controller 364 may use a number of different feedback control algorithms (e.g., each of the one or more equipment controllers 350 at the hydrocarbon site 100 may include a different control algorithm). Nonlimiting examples of control algorithms that may be implemented (e.g., used, performed, executed, etc.) by the feedback controller 364 include a PID controller, optimal tracking controllers such as a linear quadratic regulator, a lead compensator, a lead-lag controller, a state-feedback controller (e.g., designed by pole placement), observer-based controllers, a model predictive controller, an extremum seeking controller, etc.

The control algorithm of the feedback controller 364 may include a number of parameters that define the behavior of the control algorithm. For example, by changing the parameters, the control algorithm may be tuned (e.g., adjusted, modified, etc.) to exhibit certain behavior such as faster response, less overshoot, energy efficiency, etc. In some embodiments, the site controller 400 is configured to determine parameters for the feedback controller 364.

In some embodiments, the feedback controller 364 is configured to use a PID control algorithm. PID control may be described by,

$${u}_{t} = {K}_{P} {e}_{t} + {K}_{I} {\sum }_{m = 0}^{t} {e}_{m} Δ T + {K}_{D} \frac{{e}_{t} - {e}_{t - 1}}{Δ T}$$

where eₜ is the current control error (e.g., at time instance t), uₜ is the control action (e.g., the output of the feedback controller 364 to be sent to the one or more actuators 304), ΔT is the sampling interval (e.g., period of the control algorithm), and K_{P}, K_{I}, and, K_{D}, are controller parameters—the proportional gain, the integral gain, and the derivative gain, respectively. It is noted that additional parameters may also be used in some implementations of the PID control algorithm. For example, the derivative term may include a filter to reduce noise amplification from the calculation of the derivative. The PID control algorithm may also eliminate some parameters; for example, K_{D} may be set to zero for proportional-integral (PI) control. The parameterization of the PID controller is also understood to not be unique. For example, the PID may be parameterized in terms of an integral time, a proportional band, and/or a derivative time. The PID may provide the same functionality with different parameterizations. In some embodiments, the site controller 400 is configured to provide PID control parameters (e.g., K_{P}, K_{I}, and K_{P}) to the feedback controller 364.

Although the feedback controller 364 is described as a PID controller in several embodiments herein, it is understood that the feedback controller 364 may be any type of control algorithm including those listed above. For example, the feedback controller 364 may be a linear quadratic regulator (LQR) controller and may be parameterized based on the elements of the state weighting matrix Q and the elements of the input weighting matrix R. As another example, the feedback controller 364 may be a lead-lag controller and may be parameterized by the location (e.g., in the complex number plane) of the poles and zeros of its transfer function. As yet another example, the feedback controller 364 may be an observer-controller algorithm and may be parameterized based on the eigenvalues of the observer and controller portions of the algorithm. In any such algorithm used by the feedback controller 364, the site controller 400 may be configured to provide the parameters, for example, to adjust the behavior of its control (e.g., to maintain the operating point within an admissible set).

The memory 408 is shown to include instruction sets (e.g., circuits, functionality, code, etc.) used to perform the operations of the site controller 400. The memory 408 may include a reinforcement learning trainer 412, a performance term generator 414, a penalty term generator 416, a reinforcement learning controller 418, a system modeler 420, a barrier function generator 422, a constraint-based control adjuster 424, and a UI generator 426 managed by a control coordinator 410.

The control coordinator 410 may be configured to control the timing and flow of data through the other circuitry of the site controller 400. For example, the control coordinator 410 may cause the modules or circuits to execute in a specific order to perform the function of the site controller 400. In some embodiments, the control coordinator 410 may route the information and/or outputs of other modules that are dependent on the information or use the information as an input.

The site controller 400 may be configured to generate a nominal control action (e.g., a desired operating point) based on the measurements of the one or more sensors 302, adjust the nominal control action based on one or more constraints (e.g., barrier function constraints), and transmit the adjusted control action to be implemented by the one or more actuators 304. In some embodiments, the reinforcement learning controller 418 is configured to generate the nominal control action by way of a reinforcement learning algorithm and the constraint-based control adjuster 424 is configured to adjust the nominal control action to ensure stability of control and/or other desirable properties such as minimal overshoot, rapid response, etc. For example, the control action may be adjusted to cause the operating point to remain in a desired (e.g., admissible) region even in the presence of noise, disturbances, and/or model inaccuracy.

The reinforcement learning trainer 412 may be configured to train the reinforcement learning controller 418. The goal of the reinforcement learning controller 418 may be to maximize a cumulative reward function over time. The expected reward into the future may be discounted (e.g., multiplied by a number between 0 and 1 for each step into the future) in order to ensure convergence of the reward function. The reward function may reward certain performance aspects. For example, the reward function may give positive consideration to states (e.g., operating points) where production is high, efficiency (e.g., of the pump or motor) is high, and cost is low. The reward function may also penalize operating points where adverse conditions may occur or operating points near where the adverse conditions may occur. For example, the reward function may give negative consideration to states or operating points where excessive equipment wear or erosion may occur or where hydrate formation can occur.

To calculate the reward function, the reinforcement learning trainer 412 may acquire various measurements from the one or more sensors 302. The measurements may be used to calculate a performance term related to the system performance (e.g., efficiency or production) and a penalty term, for example, related to the probability of an adverse condition occurring. The performance term and the penalty term may be weighted together into a single reward function. The performance term may be weighted more heavily as the operating point moves away from any potential for adverse conditions, for example, into the interior of the desired (e.g., admissible) operating region, and the penalty term may be weighted more heavily as the operating point moves towards the boundary, as in:

$${r}_{total} = [ ( 1 - w ( x ) ) {r}_{performance} ] - w ( x ) {r}_{penalty} ,$$

where rₜₒₜₐₗ is the total reward, r_{performance} is the performance term, r_{penalty} is the penalty term, and w(x) is the weighting function as it depends on the operating point, x. The weighting function may be a function between 0 and 1. In some embodiments, the weighting function is a sigmoid-type function that depends on the distance between the operating point and the boundary of the desired operating region (e.g., d(x)). In some embodiments, the weighting function is equal to or is based upon a bounding parameter of a control barrier function described herein. In some embodiments, the weighting function is a nondecreasing function of a bounding parameter of a control barrier function (e.g., distance from the boundary of the desired operating region) and (1−w(x)) is a nonincreasing function of the bounding parameter. A nondecreasing function of the bounding parameters may refer to a function that increases or stays constant as the bounding parameter increases (e.g., the derivative with respect to the bounding parameter is greater than or equal to 0). A nonincreasing function of the bounding parameters may refer to a function that decreases or stays constant as the bounding parameter increases (e.g., the derivative with respect to the bounding parameter is less than or equal to 0)

As the control system explores more operating points and chooses (e.g., selects or determines) actions within those states, the reinforcement learning trainer 412 can generate a mapping between (i) the state and action and (ii) the reward obtained and future rewards from future states. Based on the mapping, the reinforcement learning controller 418 may be able to make more optimal decisions while the reinforcement learning trainer 412 continues to refine the mapping and improve the control. In some embodiments, the reinforcement learning trainer 412 may implement Q-type learning. The reinforcement learning trainer 412 may update the mapping function for a particular state and action combination each time it performs that action from within that state. For example, the mapping may be updated according to:

$${Q}^{+} ( {x}_{t} , {u}_{t} ) = ( 1 - μ ) Q ( {x}_{t} , {u}_{t} ) + μ [ {r}_{total} + γ {max}_{u} Q ( {x}_{t + 1} , u ) ] ,$$

where Q⁺(xₜ, uₜ) represents the updated mapping for the operating point and the action taken at the current iteration, uₜ, μ is a learning rate, γ is a discount factor between 0 and 1 and xₜ₊₁ is the next state achieved based on taking the action uₜ. The mapping Q(xₜ, uₜ) may be stored in a look-up table. Additionally or alternatively, the mapping Q(xₜ, uₜ) may be approximated by a parameterized function. For example, the mapping Q(xₜ, uₜ) may be approximated by a convolutional neural network.

In some embodiments, a first portion of the learning may be performed offline, for example, using a simulated model of the motor, well, hydrocarbon site, etc. In such a simulated environment, the reinforcement learning trainer 412 may focus on exploring different state/action combinations without affecting the performance of the overall control strategy. Once the controller is placed in situ, the controller may be able to exploit the learned behavior without significant exploration of potentially suboptimal actions. In some embodiments, the reinforcement learning trainer 412 may perform a general training for the task the controller will be performing, followed by a more specific training for the model number or equipment number that the site controller 400 will be controlling. Both the general training and the more specific training may be performed offline using a simulated model of the motor, well, hydrocarbon site, etc.

In some embodiments, after the site controller 400 is deployed (e.g., to control the controlled system 301), the goal of the reinforcement learning controller 418 is to maximize the future reward, which with proper training/learning drives the operating point of the controller away from any undesirable operating regions and maximizes the performance of the equipment or well site within the interior of the desired operating region. However, it may be advantageous to continue learning, for example, to learn the specifics of the current site and/or to adapt to any changes. To continue learning, the reinforcement learning trainer 412 may cause the reinforcement learning controller 418 to choose an action uₜ to implement that is suboptimal (e.g., according to the current mapping Q(xₜ, uₜ) stored). In some embodiments, the reinforcement learning trainer 412 may cause the reinforcement learning controller 418 to choose a random action 10% of the time. Additionally or alternatively, an action may be chosen with a probability based on its distance from the current optimal action. In some embodiments, the amount of time (e.g., the percentage) spent exploring suboptimal actions may be reduced (e.g., as the reinforcement learning controller 418 becomes more tuned to the current site).

The performance term generator 414 may be configured to generate the performance term of the reward function. The performance term may be any function related to the performance of the control system. For example, the performance term may include the overall site cost, system efficiency, well production, total revenue, and/or profit. The performance term generator 414 may receive measurements (e.g., electrical current, voltage, power factor; hydrocarbon extraction rate or flow, etc.) from the one or more sensors 302 and calculate a performance term based on those measurements. The performance term calculated by the performance term generator 414 may be based on a metric, an objective, or a cost function (e.g., negative cost). For example, the performance term generator 414 may multiply a measured flow rate by a current value of the hydrocarbon being extracted. Additionally or alternatively, the performance term generator 414 may multiply the electricity used by the pumps and/or other devices used to extract the hydrocarbon by an electricity rate to calculate a cost. In some embodiments, the performance term may be based only on the state that the system is in (e.g., its operating point) and the performance term may be independent of the action.

The penalty term generator 416 may generate a penalty term based on a probability of an adverse condition occurring within the system. Regions of operation where adverse conditions are known to occur may be stored by the penalty term generator 416. Regions not included (e.g., the logical complement of the regions of operation where adverse conditions may occur) may form the desired operating region (e.g., and be used to generate the admissible region). The penalty term may be indicative of how close the operating point is to the boundary of the desired operating region and/or by what amount the operating point has deviated from the desired operating region (e.g., which may be related to the probability of the adverse condition occurring). The penalty term generator 416 may receive measurements from the one or more sensors 302 and calculate the penalty term based on such measurements. For example, pressure, temperature, and flow of the hydrocarbon leaving the well may all be used to specify a desired operating region and subsequently monitor site operations to ensure that the desired operating region remains satisfied.

A reward function that weights both performance and distance from the boundary may train the reinforcement learning controller 418 to move towards the interior of the desired operating region and maximize control performance within that region. As described herein, the penalty term may be an amount of constraint violation, a distance from the nearest constraint, a negative of a constraint margin, or any other term that may be used to incentivize operating within the interior of the desired operating region. Once inside the desired operating region (e.g., where adverse conditions are less likely to occur), the performance term may be used to incentivize operating at maximum equipment efficiency, lowering extraction cost, and/or maximizing production.

In some embodiments, the site controller 400 includes the system modeler 420 configured to generate and/or save a model of the system that the site controller 400 is controlling (e.g., the controlled system 301). The system model may be used to perform offline training (e.g., to quickly generate an approximate mapping of Q(xₜ, uₜ)). Additionally or alternatively, the system model may be used to generate barrier functions specific to the current control system. The system modeler 420 may include a preloaded model of the system that is being controlled. The system may be stored in a state-space format, wherein the next state is a function of the current state and the control action as in:

$${x}_{t + 1} = {f}_{d} ( {x}_{t} , {u}_{t} ) ,$$

or in the continuous time form

$$\dot{x} = {f}_{c} ( x , u ) ,$$

where dot notation represents the derivative with respect to time. In some embodiments, the system is an affine function with respect to the control action:

$$\dot{x} = f ( x ) + g ( x ) u .$$

In some embodiments, the system modeler 420 may perform system identification in order to generate the system model in the desired form. The system model may be a function of several parameters; for example, the functions f(x) and g(x) may depend on a set of parameters and the system modeler 420 may be configured to identify (e.g., fit) the parameters based on training data collected from the current system under control. For example, the system modeler 420 may adjust the parameters of the system model to minimize the difference between a simulation of the system using the control actions that were applied during collection of the training data and the system output (e.g., states and/or measurements) in the training data. In some embodiments, the system model may be periodically refitted (e.g., after a certain amount of time, or if the model falls below a threshold performance level) using recently collected training data and/or previously used training data.

In some embodiments, the system model allows control decisions (e.g., the actions of the reinforcement learning trainer 412 and the reinforcement learning controller 418) to be generated in terms of the next desired state, instead of the control action taken. The system model may be used to back-calculate the control action that would transition the system from the current state to the next desired state.

The site controller 400 may include the barrier function generator 422 in order to generate additional constraints based on the desired operating region and how the control action causes the current operating point (e.g., state) to move within the desired operating region. The barrier function generator 422 may acquire (e.g., receive, generate, calculate, etc.) a function, h(x), used to describe the desired operating region (e.g., admissible set), S_{f}, by all values of the states x for which h(x) is less than or equal to zero:

$${S}_{f} {=}^{Δ} \{ x ∈ X : h ( x ) \leq 0 \} .$$

Although the desired operating region is defined herein as operating points for which the function, h(x), is negative or zero, a person of ordinary skill in the art would understand that the systems and methods described herein may be adapted for an operating region defined by a positive region.

Constraints may be configured to use the barrier function to ensure that the operating point remains within the desired operating region S_{f}. For example, constraints may be generated to ensure that a control action does not cause an increase in the barrier function h(x) that would cause the barrier function to rise above zero (e.g., indicating that the operating point or state has deviated from the desired operating region). The barrier function generator 422 may represent the rate of change or amount of change of the barrier function h(x) in terms of an affine function of the control action u to allow for constraints on the control action that can be efficiently applied in the constraint-based control adjuster 424.

The rate of change (e.g., in a continuous formulation) or amount of change (e.g., in a discrete formulation) may be represented by an affine function of the control action u:

$$Δ h = {L}_{f} h ( x ) + {L}_{g} h ( x ) u ,$$

where L_{f} and L_{g} are parameters used to formulate (e.g., approximate) the change in h(x) as an affine function of the control action. The barrier function is a control barrier function if there exists an extended class-K function α(·) such that for the system model,

$${inf}_{u ∈ U} [ {L}_{f} h ( x ) + {L}_{g} h ( x ) u ] \leq - α ( h ( x ) ) , ∀ x ∈ X ,$$

where U is the set of control actions and X is the set of states or operating points. The above equation indicates it is possible to find a control action that decreases the barrier function by at least a particular amount if the operating point is outside of the desired operating region and causes the barrier function to increase by at most a particular amount if the operating point is within the desired operating region. It is contemplated that the function α(·) may be a linear function (e.g., a multiplicative constant with the barrier function).

Given an appropriate control barrier function, constraints on the control action may be defined by:

$${L}_{f} h ( x ) + {L}_{g} h ( x ) u \leq - α h ( x ) ,$$

and used to ensure that the control action does not cause an increase in the barrier function to a value above zero. Additionally or alternatively, the control barrier constraints may drive the value of the barrier function towards zero (e.g., and thus drive the operating point towards the desired operating region) by ensuring that the change in the barrier function is negative if the operating point is outside of the desired operating region.

In some embodiments, the barrier function generator 422 chooses the value of α to be dynamic (e.g., changes as a function of time or another variable that changes with time). For example, α may be a function of the operating point or state x or more specifically the distance between the boundary of the operating region and the operating point. The dynamic values of α may be chosen advantageously, to drive the operating point quickly towards the desired operating region and/or to allow the value of the barrier function h(x) to increase more significantly if the new operating point would enhance performance while still remaining within the desired operating region. In some embodiments, the α is updated based on a dynamic update equation:

$${\dot{α}}_{dynamic} ( t ) = η ( h ( x ) , {α}_{dynamic} ) ,$$

where the update equation η is a nonlinear and locally Lipschitz.

In some embodiments, the constraint-based control adjuster 424 is configured to update a nominal control action, u_{RL}, of the reinforcement learning controller 418 based on the constraints of the barrier function generator 422 described herein and/or any additional constraints based on the equipment specifications (e.g., maximum current ratings, maximum pressure ratings, etc). The constraint-based control adjuster 424 may adjust the control action a minimal amount while satisfying all constraints. For example, the constraint-based control adjuster 424 may be configured to perform a quadratic program optimization. The quadratic program may use an objective function based on the distance (e.g., the 2-norm in the case of a quadratic program) between the nominal control action recommended by the reinforcement learning controller 418 and the implemented (e.g., admissible, constrained, etc.) control action output from the constraint-based control adjuster 424. The quadratic program is given by:

$${u}_{i m p} = {arg min}_{u ∈ U} \frac{1}{2} {‖ u - {u}_{R L} ‖}^{2} ,$$

$$s . t . {u}_{min} \leq u \leq {u}_{max} , and$$

$${L}_{f} h ( x ) + {L}_{g} h ( x ) u \leq - α h ( x ) ∀ x ∈ X .$$

In some embodiments, other objective functions are used and/or other optimization algorithms are used in order to adjust the nominal control action from the action calculated by the reinforcement learning controller 418 to values that can be implemented. For example, a one-norm may be used with linear programming or an arbitrary convex objective function may be approximated with piecewise linear segments and optimized using a linear programming algorithm. In some embodiments, the objective function may also include terms related to the performance of the site control system 300. Advantageously, if the control action must be adjusted to meet the constraints, the action may be adjusted in a direction that is most beneficial to system performance. To solve the minimization problem, the constraint-based control adjuster 424 may determine the candidate control action, u, with a lowest distance from the nominal control action and that satisfies the constraints.

The constraint-based control adjuster 424 may generate candidate control actions. The objective function may be used to select good (e.g., best, optimized, enhanced, efficient, etc.) candidate control actions. For example, an optimization routine may generate a candidate control action, evaluate the objective function, and determine another candidate control action to evaluate based on the output of the objective function. An implemented control action may be selected when the values of the objective function reach a stopping condition, or when optimization is otherwise stopped. Alternatively, multiple candidate control parameters may be evaluated (e.g., in a grid-based search).

The constraint-based control adjuster 424 may be configured to output the nominal control action, u_{RL}, from the reinforcement learning controller 418 responsive to the constraints being infeasible (e.g., if no nominal control action can simultaneously satisfy all constraints used by the constraint-based control adjuster 424). The site controller 400 may be configured to operate the system using either the implemented control action or the nominal control action based on the output from the constraint-based control adjuster 424. Advantageously, even when the constraints are infeasible, the nominal control action may drive the system towards the desired operating region (e.g., causing the constraints to become feasible again) because the reinforcement learning algorithm is trained with penalty terms related to the boundaries of the desired operating region.

In some embodiments, the site controller 400 is configured to output parameters for the feedback controller 364 (e.g., rather than the control action). For example, the site controller 400 may generate (and output) control parameters that are optimal (e.g., according to the reinforcement learning controller 418) and are configured to (e.g., expected to, predicted to, etc.) maintain the operating point within the desirable operating region (e.g., admissible set). For example, the site controller 400 may not be configured to communicate directly with the one or more actuators 304, or the one or more equipment controllers 350 may not be configured to accept control actions directly (however, the one or more equipment controllers 350 may be configured for updates to the parameters). Similarly, the site control system 300 may use one or more equipment controllers 350 to ensure control in the event of a failure of the network 310 or the site controller 400. Advantageously, by communicating control parameters (e.g., rather than the control action), the site controller 400 can provide control configured to maintain the system in a desirable operating region for systems with such configurations.

The reinforcement learning controller 418 may be configured to generate an approximate mapping of Q(xₜ, uₜ) in terms of the controller parameters, for example, as in Q (xₜ, K_{P}, K_{I}, K_{D}) or Q(xₜ, uₜ (K_{P}, K_{I}, K_{D})). The reinforcement learning controller 418 may be configured to determine the reward for choosing various controller parameters while at different states within the operating region. In some embodiments, the reinforcement learning controller 418 selects an optimal value of K_{P}, K_{I}, and, K_{D} based on the current reward mapping function Q(xₜ, K_{P}, K_{I}, K_{D}).

The barrier function generator 422 may be similarly modified to operate based on the values of control parameters (e.g., rather than a control action). For example, the barrier function generator 422 may generate a control barrier function such that there exists an extended class-K function α(·) such that for the system model,

$${inf}_{[ {K}_{P} , {K}_{I} , {K}_{D} ] ∈ K} [ {L}_{f} h ( x ) + {L}_{g} h ( x ) u ( {K}_{P} , {K}_{I} , {K}_{D} ) ] \leq - α ( h ( x ) ) , ∀ x ∈ X ,$$

where K is the set of possible control parameters (e.g., the tuples [K_{P}, K_{I}, K_{D}] in the case of a PID controller). Similarly, the constraints generated by the barrier function generator 422 may be modified as in,

$${L}_{f} h ( x ) + {L}_{g} h ( x ) u ( {K}_{P} , {K}_{I} , {K}_{D} ) \leq - α h ( x ) ,$$

and used to ensure that the control parameters do not cause an increase in the barrier function to a value above zero (e.g., indicating transitioning outside the desired operating region). Additionally or alternatively, the control barrier constraints may cause the selected values for the control parameters to drive the value of the barrier function towards zero (e.g., and thus drive the operating point towards the desired operating region) by ensuring that the change in the barrier function is negative if the operating point is outside of the desired operating region. In some embodiments, the α is updated based on a dynamic update equation:

$${\dot{α}}_{dynamic} ( t ) = η ( h ( x ) , {α}_{dynamic} ) ,$$

where the update equation η is a nonlinear and locally Lipschitz.

The constraint-based control adjuster 424 may be configured to update a nominal set of control parameters (e.g., [K_{P}, K_{I}, K_{D}]) from the reinforcement learning controller 418 based on the constraints of the barrier function generator 422 described herein and/or any additional constraints based on the equipment specifications (e.g., maximum current ratings, maximum pressure ratings, maximum allowable values of [K_{P}, K_{I}, K_{D}], etc.). The constraint-based control adjuster 424 may adjust the values of the control parameters (e.g., nominal values) an amount in order to satisfy the constraints. For example, the constraint-based control adjuster 424 may be configured to perform a quadratic program optimization. The quadratic program may use an objective function based on the distance (e.g., the 2-norm in the case of a quadratic program) between the nominal control parameters recommended by the reinforcement learning controller 418 and the implemented (e.g., constrained) control parameters output from the constraint-based control adjuster 424 and to be transmitted to the one or more actuators 304. The quadratic program may be given by:

$${[ {K}_{P} , {K}_{I} , {K}_{D} ]}_{i m p} = {arg min}_{[ {K}_{P} , {K}_{I} , {K}_{D} ] ∈ K} \frac{1}{2} {‖ [ {K}_{P} , {K}_{I} , {K}_{D} ] - {[ {K}_{P} , {K}_{I} , {K}_{D} ]}_{R L} ‖}^{2} ,$$

$$s . t . {K}_{P , min} \leq {K}_{P} \leq {K}_{P , max} ,$$

$${K}_{I , min} \leq {K}_{I} \leq {K}_{I , max} ,$$

$${K}_{D , min} \leq {K}_{D} \leq {K}_{D , max} ,$$

$${u}_{min} \leq u ( {K}_{P} , {K}_{I} , {K}_{D} ) \leq {u}_{max} , and$$

$${L}_{f} h ( x ) + {L}_{g} h ( x ) u ( {K}_{P} , {K}_{I} , {K}_{D} ) \leq - α h ( x ) ∀ x ∈ X .$$

In some embodiments, the objective function is weighted, for example, to indicate the relative importance of the individual control parameters. For example, the constraint-based control adjuster 424 may be configured to weight the error between the nominal and implemented control parameters using a matrix, for example,

$${[ [ {K}_{P} , {K}_{I} , {K}_{D} ] - {[ {K}_{P} , {K}_{I} , {K}_{D} ]}_{R L} ]}^{T} M [ [ {K}_{P} , {K}_{I} , {K}_{D} ] - {[ {K}_{P} , {K}_{I} , {K}_{D} ]}_{R L} ] .$$

Other (e.g., nonsymmetric, etc.) objective functions may be used by the constraint-based control adjuster 424. For example, the constraint-based control adjuster 424 may weight positive errors in K_{P} more heavily than negative errors because larger gains are more likely to cause instability. As another example, the objective function may use the 1-norm, resulting in a linear program optimization.

The constraint-based control adjuster 424 may generate candidate control parameters. The objective function may be used to select good (e.g., best, optimized, enhanced, efficient, etc.) candidate control parameters. For example, an optimization routine may generate candidate control parameters, evaluate the objective function, and determine another set of candidate control parameters to evaluate based on the output of the objective function. An implemented control parameter may be selected when the values of the objective function reach a stopping condition, or when optimization is otherwise stopped. Alternatively, multiple candidate control parameters may be evaluated (e.g., in a grid-based search).

The constraint-based control adjuster 424 may output the nominal control parameters if the constraints become infeasible. For example, if no control parameters can simultaneously satisfy all constraints, the nominal control parameters may be provided. The nominal control parameters provided by the reinforcement learning controller 418 may cause the operating point of the controlled system 301 to move towards the desired operating region causing the constraints of the constraint-based control adjuster 424 to again become feasible.

In some embodiments, the constraint-based control adjuster 424 generates new values for [K_{P}, K_{I}, K_{D}] at each time sample the output of the feedback controller 364 is to be updated (e.g., each sampling instant of the one or more equipment controllers 350). For example, the reinforcement learning controller 418 may generate nominal values for [K_{P}, K_{I}, K_{D}] at one period (e.g., a slower period), while the constraint-based control adjuster 424 operates to generate control parameters that satisfy the constraints at the same sampling rate as the feedback controller 364.

In some embodiments, the constraint-based control adjuster 424 may be disposed on (e.g., within, etc.) the one or more equipment controllers 350 to reduce the information that is communicated over the network 310. The reinforcement learning controller 418 may provide control parameters at a lower frequency than the update frequency for the feedback controller 364, for example, to adjust for changes that can occur over a longer time period (e.g., environmental changes related to weather, conditions at the well site 200, congestion in transportation pipelines, etc.), while the constraint-based control adjuster 424 can adjust a nominal control action from the feedback controller 364 (e.g., a PID controller), generated using the current control parameters from the last update of the reinforcement learning controller 418. Advantageously, the constraint-based control adjuster 424 may adjust each control action determined by the PID before it is transmitted to the one or more actuators 304 to ensure compliance with the constraint from the barrier function generator 422 and that the operating point is controlled to remain within the desired operating region.

The UI generator 426 may provide instructions to the one or more UI clients 306 (e.g., JavaScript, Cascading Style Sheets) that instruct the one or more UI clients 306 how to generate a user interface within a client application (e.g., an internet browser, a proprietary application, etc.). The user interface may display information related to the configuration of the site controller 400, the savings generated using the control algorithm described herein, and/or adjustments made by the constraint-based control adjuster 424 (e.g., that may be indicative of additional potential savings if the adjustments were not made). In some embodiments, the UI generator 426 can provide application programming interfaces (APIs) that allow remote configuration or updates of the site controller 400, for example, based on a user role.

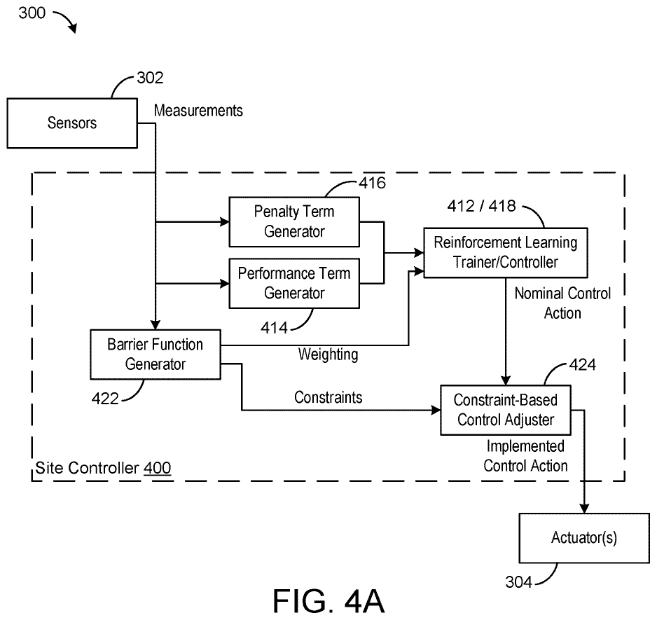

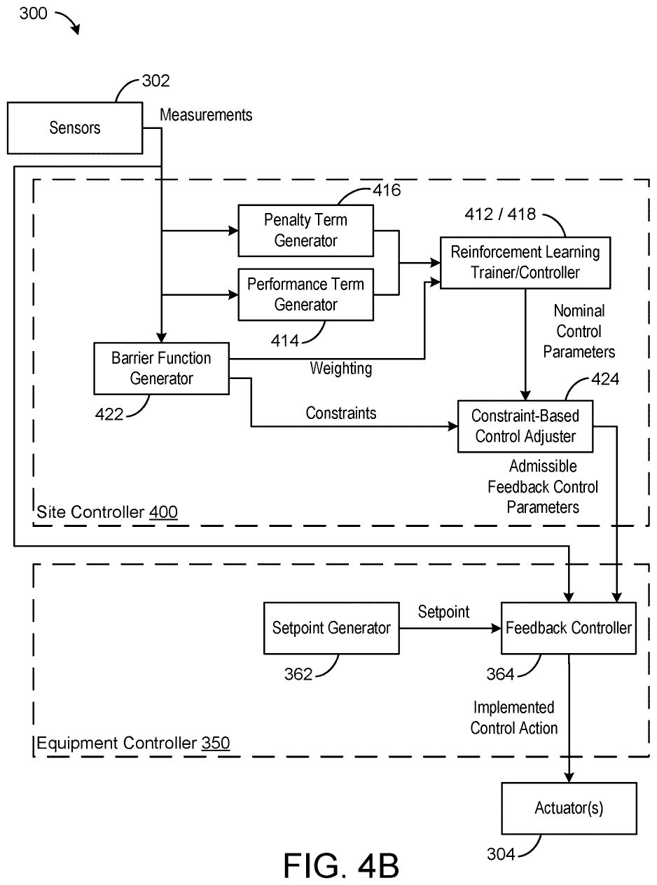

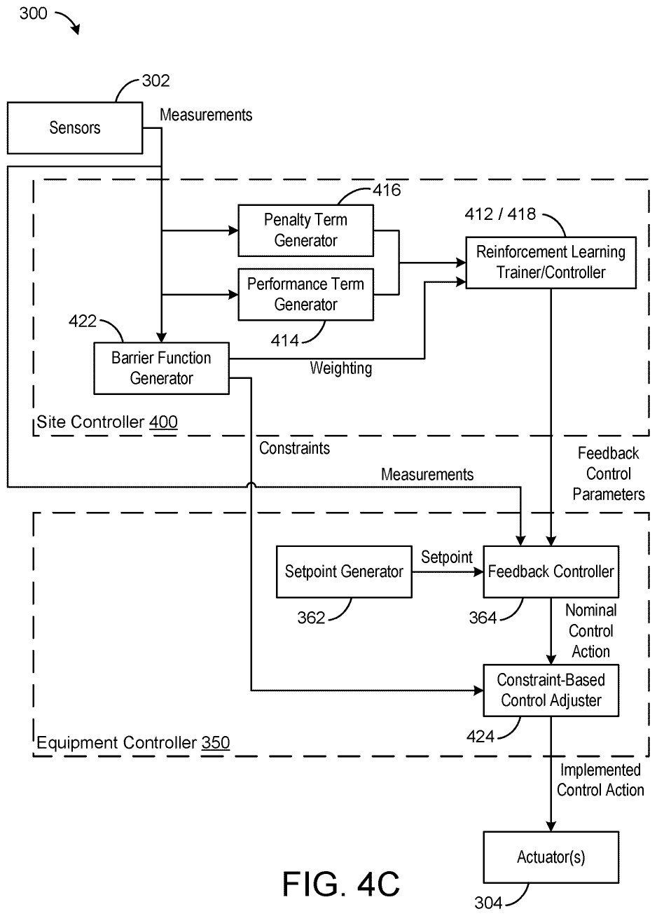

FIG. 4A shows a signal flow diagram including the components of the site control system 300 and the site controller 400 according to some embodiments. In FIG. 4A, the site controller 400 is shown configured to send control actions directly to the one or more actuators 304 (e.g., without one or more equipment controllers 350). To generate appropriate control actions, the site controller 400 uses measurements from the one or more sensors 302. The measurements may be sent to (e.g., communicated to, used as an input to, etc.) the penalty term generator 416, the performance term generator 414, and the barrier function generator 422.

The conditions measured may influence the production and cost associated with the current operating point and thus may be used to calculate a portion of the reward associated with the current operating point calculated by the performance term generator 414. The performance term may include the overall site cost, system efficiency, well production, total revenue, and/or profit based upon measurements of the electrical current, voltage, power factor; hydrocarbon extraction rate or flow, etc. from the one or more sensors 302 as described above. The current measurements may also be used to calculate the penalty term associated with the current operating point (e.g., by the penalty term generator 416). In some embodiments, the penalty term is a constant value and the weighting between the penalty and the performance terms causes the applied penalty to be based on the distance between the operating point and the boundary of the desired operating region. Additionally or alternatively, the penalty term itself may depend on the distance between the operating point and the boundary of the desired operating region.

In some embodiments, the measurements from the one or more sensors 302 are received by the barrier function generator 422. The measurements provide observability to the state (e.g., the operating point) and may be used by the barrier function generator 422 to determine the constraint,

$${L}_{f} h ( x ) + {L}_{g} h ( x ) u \leq - α h ( x ) .$$

For example, the operating point may be used to evaluate the barrier function, h(x), at the operating point x. The operating point and therefore the measurements may also be used to calculate the value for α, for example, if α depends on the distance between the operating point and the boundary of the desired operating region or if α updates based on the update equation,

$${\dot{α}}_{dynamic} ( t ) = η ( h ( x ) , {α}_{dynamic} )$$

where the update equation η is nonlinear and locally Lipschitz. The constraints generated by the barrier function generator 422 may be communicated to the constraint-based control adjuster 424 to be used in the adjustment process, for example, to ensure the control action causes the operating point to move towards the desired operating region defined by h(x) or to remain within the desired operating region.

The barrier function generator 422 may also determine a weighting between the penalty term and the performance term to be used as the overall reward within the reinforcement learning trainer 412 and the reinforcement learning controller 418. The penalty may be weighted more heavily as the controller approaches the boundary of the desired operating region. For example, the weighting may be based on a dynamic value of α.

The performance term provided by the performance term generator 414, the penalty term provided by the penalty term generator 416, and the weighting provided by the barrier function generator 422 allow the reinforcement learning controller 418 to adjust its control based on the new information received. For example, each time a measurement is received, the reinforcement learning trainer 412 may update the value mapping according to:

$${Q}^{+} ( {x}_{t} , {u}_{t} ) = ( 1 - μ ) Q ( {x}_{t} , {u}_{t} ) + μ [ {r}_{total} + γ {max}_{u} Q ( {x}_{t + 1} , u ) ] ,$$

where Q⁺(xₜ, uₜ) represents the updated value mapping for the operating point and the action taken at the current iteration, uₜ, μ is a learning rate, γ is a discount factor between 0 and 1 and xₜ₊₁ is the next state achieved based on taking the action uₜ with:

$${r}_{total} = [ ( 1 - w ( x ) ) {r}_{performance} ] - w ( x ) {r}_{penalty} ,$$

where rₜₒₜₐₗ is the total reward, r_{performance} is the performance term, r_{penalty} is the penalty term, and w(x) is the weighting function as it depends on the operating point, x as described previously. The reinforcement learning controller 418 may determine a control action by selecting, from the value mapping, the action with the highest value from the current operating point or state. Given enough time to train, the value mapping may converge, and the controller may identify near optimal actions for each state, providing efficient control. In some embodiments, the reinforcement learning trainer 412 may cause the reinforcement learning controller 418 to explore alternative control actions (e.g., alternatives to what is currently optimal according to the value mapping) periodically. For example, the reinforcement learning controller 418 may select an alternative control action a given percentage of the time at random (e.g., 10%, 20%, etc.). Advantageously, exploring alternative actions allows the reinforcement learning controller 418 to adapt to changing conditions.

Conventional reinforcement learning-based controllers can suffer from an inability to ensure that the control actions adhere to a set of constraints that avoid adverse conditions related to operating in an undesirable region. This may be especially true during initial training or during control actions meant to explore alternative actions. For example, in the hydrocarbon extraction industry, certain high flow rates and/or pressures can cause increased equipment wear and/or hydrate formation that can be detrimental to the performance of a well. The systems and methods of the present disclosure may ensure that the control actions implemented either keep the operating point within a desired (e.g., acceptable) region or quickly drive the operating point towards the acceptable region by way of the constraint-based control adjuster 424.

The constraint-based control adjuster 424 may be configured to receive the nominal control action, u_{RL}, from the reinforcement learning controller 418 and the constraints from the barrier function generator 422. The nominal control action may be used to generate an objective function. For example, a quadratic objective function may be the distance between the nominal control action from the reinforcement learning controller 418 and the implemented control action that is output from the constraint-based control adjuster 424 as in:

$$J = \frac{1}{2} {‖ u - {u}_{R L} ‖}^{2} .$$

Other objective functions may be used by the constraint-based control adjuster 424 as described previously. The constraint-based control adjuster 424 may minimize the objective function subject to constraints from the barrier function generator 422. For example, the constraint-based control adjuster 424 may ensure that the implemented control action satisfies equipment constraints (e.g., maximum current constraints, minimum flow constraints, etc.) as in:

$${u}_{min} \leq u \leq {u}_{max} ,$$

and satisfies the barrier function-based constraints to ensure that the control action drives the evaluation of the barrier function h(x) towards zero (e.g., drives the operating point towards the desired operating region), and once there, maintains the evaluation of h(x) at or below zero (e.g., maintains the operating point within the desired operating region). The barrier function-based constraints may be given by:

$${L}_{f} h ( x ) + {L}_{g} h ( x ) u \leq - α h ( x ) ∀ x ∈ X ,$$

as described previously. The constraint-based control adjuster 424 may determine an implemented control action, uᵢₘₚ, that minimizes the objective function subject to the constraints received.

The implemented control action may be output from the site controller 400 and sent to the one or more actuators 304 to control (e.g., operate) the system (e.g., motor, well site, hydrocarbon site, etc.) according to the implemented control action uᵢₘₚ. In some embodiments, the implemented control action uᵢₘₚ is in terms of one or more high level control variables (e.g., setpoint) for which there is direct actuation available. For example, an element of uᵢₘₚ may be an outlet pressure from the well. This pressure may not be directly implemented by the actuators; instead, the actuator may need a choke position to control the pressure. The choke position may control the pressure to the value in uᵢₘₚ by way of a proportional-integral-derivative (PID) controller wherein the choke position is modulated to maintain the expected pressure. Additionally (as in feedforward control) or alternatively, a model may be used to determine the choke position for a given pressure. Advantageously, the PID controller allows for feedback to adjust the choke position for disturbances affecting the pressure and/or model inaccuracies. In some embodiments, the reinforcement learning controller 418 directly learns the control actions in terms of low level control actions such as the choke position, which may be sent directly to the actuator.

FIG. 4B shows a signal flow diagram including the components of the site control system 300, a controller of one or more equipment controllers 350, and the site controller 400 according to some embodiments. In FIG. 4B, the equipment controller 350 is shown to provide an implemented control action to the one or more actuators 304 using the feedback controller 364, whereas the site controller 400 is shown configured to provide admissible feedback control parameters. For example, admissible feedback control parameters may refer to feedback control parameters that have been appropriately constrained by the constraint-based control adjuster 424 to ensure that the operating point of the controlled system 301 remains within a desired operating region.

The one or more sensors 302 may communicate measurements of various states and/or variable conditions of the controlled system 301 to the site controller 400 and to the one or more equipment controllers 350. The conditions measured may influence the production and cost associated with the current operating point and thus may be used to calculate a portion of the reward associated with the current operating point determined by the performance term generator 414. The performance term generator 414 may generate a performance term that includes the overall site cost, system efficiency, well production, total revenue, and/or profit based upon measurements of the electrical current, voltage, power factor, hydrocarbon extraction rate or flow, etc. from the one or more sensors 302 as described above. The penalty term generator 416 may also use the measurements to calculate the penalty term associated with the current operating point.

The barrier function generator 422 may generate a value for a based on the measurements received from the one or more sensors 302. In some embodiments, the value for a depends on the distance between a current operating point and the boundary of the desired operating region (e.g., the admissible set of operating points). For example, the barrier function generator 422 may generate a value for a near zero for operating points near the boundary, indicating that the value of the barrier function may not be able to increase without exiting the desired operating region, whereas away from the boundary and in the interior of the desired operating region the implemented control action may be given more freedom (e.g., be less constrained) to increase the value of the barrier function h(x). In some embodiments, the barrier function generator 422 updates the value for a according to the update equation,

$${\dot{α}}_{dynamic} ( t ) = η ( h ( x ) , {α}_{dynamic} )$$

where the update equation η is a nonlinear and locally Lipschitz function. Similarly, an appropriate time discretization of the update equation may be used.

The barrier function generator 422 may be configured to generate constraints using the generated value for α and provide the constraints to the constraint-based control adjuster 424 to be used to adjust control parameters. In some embodiments, the barrier function generator 422 generates the constraint,

$${L}_{f} h ( x ) + {L}_{g} h ( x ) u ( {K}_{P} , {K}_{I} , {K}_{D} ) \leq - α h ( x ) ,$$

for example, if the feedback controller 364 is a PID controller. The constraint generated by the barrier function generator 422 may parameterize the control action in terms of the control parameters of the feedback controller 364 to ensure that the implemented control action is configured to cause the operating point of the controlled system 301 to remain in the desirable operating region.

Similar to the configuration shown in FIG. 4A, the barrier function generator 422 may also be configured to provide weights for the penalty term and the performance term based on the value for α. In some embodiments, a value of α near zero indicates operation near the boundary, and the barrier function generator 422 may increase the weight of the penalty term. A larger value for α may indicate operation away from the boundary and in the interior. The barrier function generator 422 may increase the weight of the performance term in response to larger values of α. For example, the weighting function, w(x), may be a sigmoid function of α. The value of the weights for the penalty term and/or the performance term may be provided to the reinforcement learning controller 418 to facilitate adaptation of the reward function Q⁺(xₜ, K_{P}, K_{I}, K_{D}).

The reinforcement learning controller 418 may use the reward function parameterized in terms of the control parameters to determine nominal control parameters for the feedback controller 364 given the current state, xₜ (e.g., from the measurements). The reinforcement learning controller 418 may determine an optimal set of parameters (e.g., providing the greatest future reward according to the reward function).

As shown in FIG. 4B, the constraint-based control adjuster 424 may use the constraints from the barrier function generator 422 and the nominal control parameters to determine control parameters configured to (e.g., predicted to) maintain the states of the controlled system 301 within a desirable operating region when used by the feedback controller 364. The constraint-based control adjuster 424 may determine a set of admissible feedback control parameters for the feedback controller 364 by determining a set of feedback control parameters that are closest (e.g., according to an objective function) to the nominal control parameters and satisfy the constraints from the barrier function generator 422. For example, the constraint-based control adjuster 424 may find a solution (e.g., optimal value) to the quadratic program,

$${[ {K}_{P} , {K}_{I} , {K}_{D} ]}_{imp} = {arg min}_{[ {K}_{P} , {K}_{I} , {K}_{D} ] ∈ K} \frac{1}{2} {‖ [ {K}_{P} , {K}_{I} , {K}_{D} ] - {[ {K}_{P} , {K}_{I} , {K}_{D} ]}_{RL} ‖}^{2} ,$$

$$s . t . {K}_{P , min} \leq {K}_{P} \leq {K}_{P , max} ,$$

$${K}_{I , min} \leq {K}_{I} \leq {K}_{I , max} ,$$

$${K}_{D , min} \leq {K}_{D} \leq {K}_{D , max} ,$$

$${u}_{min} \leq u ( {K}_{P} , {K}_{I} , {K}_{D} ) \leq {u}_{max} ,$$

$$and$$

$${L}_{f} h ( x ) + {L}_{g} h ( x ) u ( {K}_{P} , {K}_{I} , {K}_{D} ) \leq - α h ( x ) ∀ x ∈ X .$$

It is understood that other objective functions may be used. The objective functions may or may not be quadratic, and other optimization routines (e.g., not designed for quadratic programs) may be used.

In some embodiments, the constraint-based control adjuster 424 performs a check to determine whether the feedback control parameters provided by the constraint-based control adjuster 424 satisfy the constraints (e.g., prior to performing an optimization or solving the program described above). Advantageously, determining whether feedback control parameters satisfy the constraints without performing the optimization may reduce the number of computations performed. For example, the reinforcement learning controller 418 uses weighting from the barrier function generator 422 that can cause the reinforcement learning controller 418 to favor (e.g., based on the reward function) control parameters that maintain the operating point in the interior (e.g., away from the boundary) of the desired operating region, and a majority of the nominal control parameters selected by the reinforcement learning controller 418 may satisfy the constraints.

The constraint-based control adjuster 424 may generate a new set of control parameters for the feedback controller 364 prior to the feedback controller 364 generating each output (e.g., in order to ensure that no control action causes the operating point to deviate from the desired operating region). For example, the constraint-based control adjuster 424 and the feedback controller 364 may be configured to operate at the same period and/or the constraint-based control adjuster 424 may trigger the execution of the feedback controller 364 (e.g., by providing the admissible control parameters). It is noted that the reinforcement learning controller 418 and barrier function generator 422 may operate at different frequencies (e.g., periods, etc.). In some embodiments, the reinforcement learning controller 418 updates the nominal control parameters and the barrier function generator 422 updates the value of the bounding parameter, a, of the control barrier function at a slower frequency or on demand, thereby reducing computations. For example, the reinforcement learning controller 418 may update the nominal control parameters only after a significant change in the operating point and/or other conditions that affect the reward function.

As shown in FIG. 4B, the admissible control parameters generated by the constraint-based control adjuster 424 are communicated to the feedback controller 364 (e.g., which may be disposed within the equipment controllers 350). The feedback controller 364 may generate the implemented control action according to the control algorithm implemented by the feedback controller 364. For example, the feedback controller 364 may generate the implemented control action based on an error between the setpoint from the setpoint generator 362 and the measured value from the one or more sensors 302. In some embodiments, the feedback controller 364 generates the control action based on the admissible control parameters, thereby operating the equipment according to the admissible control parameters. Following the flow diagram of FIG. 4B, the implemented control action determined by feedback controller 364 is configured to cause the operating point of the controlled system 301 to remain in the desired operating region because the constraint-based control adjuster 424 has already adjusted the control parameters to satisfy such a condition.

In some embodiments, the site controller 400 and the one or more equipment controllers 350, as shown in FIG. 4B, operate at the same period (e.g., frequency) and share data (e.g., communicate data between the devices at that same frequency). For example, the site controller 400 may communicate admissible control parameters (or an indication to use the previous parameters) at each sampling instant, and the one or more equipment controllers 350 may provide the setpoint to the constraint-based control adjuster 424 (or an indication to use the previous setpoint) to the site controller 400 to facilitate performing the control calculations within the constraints of the barrier function generator 422. It is noted that data may not be transferred on every sampling period (e.g., not sending data may be an indication to use the previous setpoint and/or control parameters).

FIG. 4C shows another signal flow diagram including the components of the site control system 300, a controller of one or more equipment controllers 350, and the site controller 400 according to some embodiments. The configuration illustrated in FIG. 4C may facilitate operating the site controller 400 and the one or more equipment controllers 350 at different frequencies and minimize the need for data transfer. As shown in FIG. 4C, the constraint-based control adjuster 424 can be disposed in the one or more equipment controllers 350, thereby allowing the constraint-based control adjuster 424 to adjust the control action generated by the feedback controller 364 directly. It is noted that the constraint-based control adjuster 424 could adjust the output of the feedback controller 364 directly even if the constraint-based control adjuster 424 were disposed in a separate device (e.g., the site controller 400); however, additional communication between the site controller 400 and the one or more equipment controllers 350 may facilitate this configuration.

According to the configuration of FIG. 4C, the reinforcement learning trainer 412 and the reinforcement learning controller 418 operate as shown in FIG. 4B. For example, the reinforcement learning trainer 412 may receive a penalty term and a performance term from the penalty term generator 416 and the performance term generator 414, respectively. In addition, the barrier function generator 422 may be configured to provide weights for the penalty and performance terms. For example, the barrier function generator 422 may generate the weights based on the sensor measurements (e.g., based on the distance between the operating point and the boundary of the desired operating region). The reinforcement learning trainer 412 may learn (e.g., generate, obtain, etc.) a reward function based on the current operating point and the control parameters (e.g., Q⁺(xₜ, K_{P}, K_{I}, K_{D})). Similarly, the reinforcement learning controller 418 may be configured to provide control parameters based on the current state using the reward function. For example, the reinforcement learning controller 418 may select (e.g., generate, etc.) control parameters that are predicted to provide the greatest reward (e.g., best control, desired behavior, etc.) over a future horizon.

The barrier function generator 422, however, may generate the constraints in terms of the control action. For example, the barrier function generator 422 may generate the constraint,

$${L}_{f} h ( x ) + {L}_{g} h ( x ) u \leq - α h ( x ) ∀ x ∈ X ,$$

as in the configuration of FIG. 4A. The constraint may be generated in terms of the control action because the constraint-based control adjuster 424, using the constraint, is disposed after the calculations of the feedback controller 364. The constraint-based control adjuster 424 may receive a nominal control action as in the configuration of FIG. 4A.

The control parameters from the reinforcement learning controller 418 may be provided to the feedback controller 364 where they can be used to generate the nominal control action according to the control algorithm used by the feedback controller 364 (e.g., PID, model predictive control, lead-lag control, etc.). For example, the feedback controller 364 may operate as a PID and calculate the nominal control action as,

$${u}_{t} ( {K}_{P} , {K}_{I} , {K}_{D} ) = {K}_{P} {e}_{t} + {K}_{I} {\sum }_{m = 0}^{t} {e}_{m} Δ T + {K}_{D} \frac{{e}_{t} - {e}_{t - 1}}{Δ T}$$

where K_{P}, K_{I}, and K_{D}, have been provided by the reinforcement learning controller 418 and the error, eₜ, is the error between a setpoint provided by the setpoint generator 362 and the sensor measurements of the controlled state or variable.

After the nominal control action has been generated by the feedback controller 364, the constraint-based control adjuster 424 may be configured to adjust the control action to ensure that the implemented control, when transmitted to the one or more actuators 304, causes the operating point of the controlled system 301 to remain within the desired operating region (e.g., admissible region, admissible set, etc.). As in the configuration of FIG. 4A, the constraint-based control adjuster 424 may be configured to adjust (e.g., modify, change, etc.) the desired control action to a control action that causes the operating point of the controlled system 301 to remain within the desired operating region. For example, the constraint-based control adjuster 424 may find the control action nearest the nominal control action from the feedback controller 364 that satisfies the constraints. In some embodiments, the constraint-based control adjuster 424 performs the quadratic program,

$${u}_{imp} = {arg min}_{u ∈ U} \frac{1}{2} {‖ u - {u}_{nom} ‖}^{2} ,$$

$$s . t . {u}_{min} \leq {u}_{imp} \leq {u}_{max} ,$$

$$and$$

$${L}_{f} h ( x ) + {L}_{g} h ( x ) {u}_{imp} \leq - α h ( x ) ∀ x ∈ X .$$

where the uₙₒₘ is acquired from the feedback controller 364 using the control parameters from the reinforcement learning controller 418. The site controller 400 may communicate the implemented control action generated by the constraint-based control adjuster 424 to the one or more actuators 304 to control the controlled system 301.

In some embodiments, the site controller 400 transmits the constraints from the barrier function generator 422 and the control parameters from the reinforcement learning controller 418. Advantageously, communication of data between the site controller 400 and the one or more equipment controllers 350 may be performed when the reinforcement learning controller 418 updates the control parameters and/or when the barrier function generator 422 generates new constraints (e.g., which could be significantly slower than the frequency at which the feedback controller 364 operates). Although FIG. 4C shows the instruction sets distributed between the one or more equipment controllers 350 and the site controller 400, it is understood that, in some embodiments, each of the components (e.g., instruction sets, etc.) may be disposed on the same hardware (e.g., on the same server device, within the same cluster, on the same node of a cluster, operating within the same service, etc.). For example, all functionality may be performed within the one or more equipment controllers 350 or within the site controller 400.

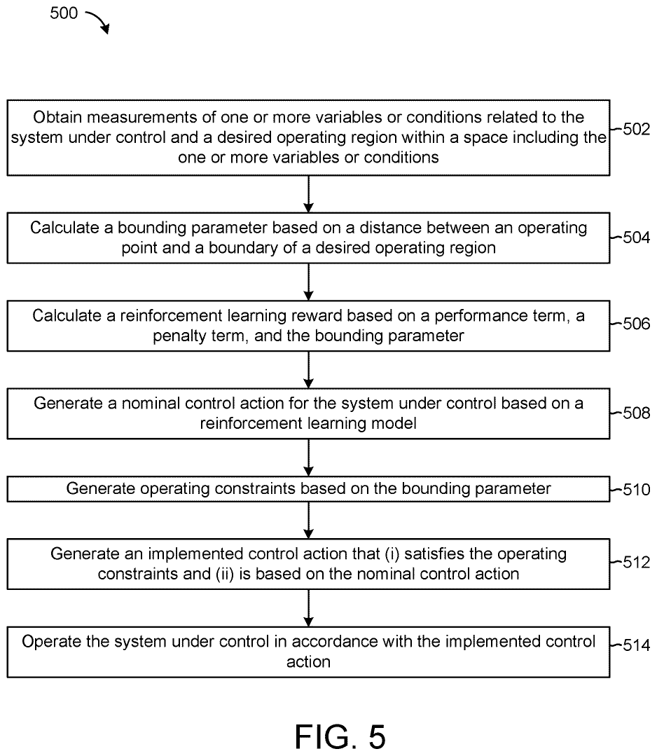

FIG. 5 shows a flow of operations 500 for site control using control barrier functions and reinforcement learning, according to some embodiments. The flow of operations 500 may be performed by the site controller 400.

The flow of operations 500 may include obtaining measurements of one or more variables or conditions related to the system under control and a desired operating region within a space including the one or more variables or conditions in operation 502. Several types of systems may be controlled by the flow of operations 500 and the site controller 400. For example, a motor may be controlled using the flow of operations 500 where the objective is to maintain stable control (e.g., without slip for synchronous machines) of the motor at increased operating efficiency. As an additional example, a well site may be controlled using the flow of operations 500 where the objective is to operate in a known region free of adverse effects (e.g., from high pressure or flow) while also minimizing the cost (e.g., electrical cost) of operating the site. The measurements used may depend on the system being controlled; for example, the measurements may include pressure measurements, fluid flow measurements, current measurements, etc. The operation 502 may be performed by the one or more sensors 302 sending (e.g., communicating) data over the network 310 to the site controller 400.

The flow of operations 500 may include calculating a bounding parameter based on a distance between an operating point and a boundary of a desired operating region in operation 504. The bounding parameter calculated in the operation 504 may include a as described related to the control barrier functions. Alternatively, a bounding parameter may be any weight used to balance a tradeoff between optimizing the control system and/or remaining within the desired operating region. For example, the bounding parameter may be the weight used by the reinforcement learning trainer 412 to calculate the reward used to train the reinforcement learning controller 418. In some embodiments, the bounding parameter is calculated by the barrier function generator 422 for use by other components of the site controller 400. For example, the constraint-based control adjuster 424, the performance term generator 414, and the penalty term generator 416 may each use the bounding parameter depending on how it is defined.

The flow of operations 500 may include calculating a reinforcement learning reward based on a performance term, a penalty term, and the bounding parameter in operation 506. For example, operation 506 may be performed by the reinforcement learning trainer 412 using the performance term generator 414 and the penalty term generator 416 to train the reinforcement learning controller 418. The performance term and the penalty term may be weighted together into a single reward function as in:

$${r}_{total} = [ ( 1 - w ( x ) ) {r}_{performance} ] - w ( x ) {r}_{penalty} ,$$

where rₜₒₜₐₗ is the total reward, r_{performance} is the performance term, r_{penalty} is the penalty term, and w(x) is the weighting function as it depends on the operating point, x. The weighting function may be a function with a range between 0 and 1 (e.g., a sigmoid-type function that depends on the distance between the operating point and the boundary of the desired operating region).

The reward function of the operation 506 may be used to cause the reinforcement learning controller 418 to determine control actions that are weighted heavily to move towards the interior of the desired operating region and, once in the interior of the operating region, maximize performance. The combination of the weighting function multiplied by the penalty term w(x)r_{penalty} may, for example, increase rapidly as the operating point, x, moves away from the boundary of and is outside the desired operating region, thus causing the reinforcement learning controller 418 to avoid such operating points. Additionally, w(x)r_{penalty} may decrease as the operating point moves away from the boundary of and is inside the desired operating region, causing the reinforcement learning controller 418 to avoid operating points near the boundary even inside the desired operating region. Away from the boundary and in the interior of the desired operating region w(x)r_{penalty} may be near zero and the performance term may dictate the operations of the reinforcement learning controller 418. The performance term may be any function related to the performance of the control system. For example, the performance term may include the overall site cost, system efficiency, well production, total revenue, and/or profit. The performance term may be calculated based on the measurements and/or the model of the system controlled by the reinforcement learning controller 418.

In some embodiments, the flow of operations 500 includes generating a nominal control action for the system under control based on a reinforcement learning model in operation 508. The reinforcement learning controller 418 may choose a control action based on the learning to date. Any type of reinforcement learning algorithm may be used in order to generate the nominal control action. The nominal control action may be determined based on the action that is expected to incur the greatest reward into the future. By way of example, if Q-learning is used to train the reinforcement learning controller 418, the reinforcement learning controller 418 may choose an action for which the value mapping Q(xₜ, uₜ) is greatest for the current state.

The flow of operations 500 may include generating operating constraints based on the bounding parameter in operation 510. The operating constraints may be used to ensure that a control barrier function does not increase to a value indicating that the operating point has exited the desired operating region. The operation 510 may be performed by the barrier function generator 422. A control barrier function may be used to define the desired operating region, S_{f}, by all values of the operating point or states x for which h(x) is less than or equal to zero:

$${S}_{f} {=}^{△} \{ x ∈ X : h ( x ) \leq 0 \} .$$

As stated above, the objective of the constraints in the operation 510 may be to ensure that the operating point or states x remain within the desired operating region once there. Based on the definition of the desired operating region, this is equivalent to ensuring that the control barrier function h(x) remains less than or equal to zero. Alternatively, the constraints in operation 510 may be used to drive the operating point towards the desired operating region if the current operating point is outside the operating region (e.g., which is equivalent to driving h(x) negative if it is currently positive).

To generate appropriate constraints, the rate of change (e.g., in a continuous formulation) or amount of change (e.g., in a discrete formulation) may be represented by an affine function of the control action u:

$$Δ h = {L}_{f} h ( x ) + {L}_{g} h ( x ) u ,$$

where L_{f} and L_{g} are parameters used to formulate (e.g., approximate) the change in h(x) as an affine function of the control action. The constraint:

$${L}_{f} h ( x ) + {L}_{g} h ( x ) u \leq - α h ( x ) ,$$

ensures that if h(x) is currently negative (e.g., the operating point is within the desired operating region) it will increase by no more than a certain amount, and with appropriate choice of α that certain amount will not cause h(x) to become positive (e.g., the operating point moves outside the desired operating region). Additionally, if h(x) is currently positive (e.g., the operating point is outside the desired operating region) h(x) will decrease by no less than a certain amount (e.g., the operating point will be driven towards the desired operating region). Applying such constraints in conjunction with reinforcement learning may overcome some deficiencies of reinforcement learning where control actions may drive the system from the desired operating region, especially during early training, during an exploration action, and/or after a significant change to the system.

The bounding parameter, α, of the constraint may be used to perform the weighting of the performance term and the penalty term during calculation of the reward in the operations 506. For example, the weighting may be a sigmoid-type function of the bounding parameter or the inverse of the bounding parameter. Appropriate choice of the dependency of the weighting function on the bounding parameter may depend on the formulation of the constraints used by the barrier function generator 422.

The flow of operations 500 may include generating an implemented control action that (i) satisfies the operating constraints and (ii) is based on the nominal control action (e.g., from a reinforcement learning-based controller) in operation 512. The operation 512 may, for example, be performed by the constraint-based control adjuster 424. In some embodiments, the operation 512 includes generating an implemented control action that is a minimal distance (e.g., as measured by the 2-norm) from the nominal control action suggested by the reinforcement learning controller 418 that also satisfies all constraints, including the barrier function-based constraints.

The operation 512 may include performing an optimization subject to the constraints on the control action. For example, a quadratic program can be solved as defined by:

$${arg min}_{u ∈ U} \frac{1}{2} {‖ u - {u}_{RL} ‖}^{2} ,$$

$$s . t . {u}_{min} \leq u \leq {u}_{max} ,$$

$${L}_{f} h ( x ) + {L}_{g} h ( x ) u \leq - α h ( x ) ∀ x ∈ X .$$

Other objective functions and/or other optimization algorithms may be used in order to adjust the nominal control action to values that can be implemented. For example, a one-norm may be used with linear programming, or an arbitrary convex objective function may be approximated with piecewise linear segments and optimized using a linear programming algorithm. In some embodiments, the objective function may also include terms related to the performance of the site control system 300. Advantageously, if the control action must be adjusted to meet the constraints, the action may be adjusted in a direction that is most beneficial to system performance.

The flow of operations 500 may include operating the system under control in accordance with the implemented control action in operation 514. Operation 514 may include the generation of electric control signals to be sent to the one or more actuators 304 of the system under control. For example, control signals defining the position of a choke valve, the frequency of a VSD, the voltage of a variable speed drive, etc. may be communicated to the respective actuator. An actuator, for example, may refer to any device that affects the operation of the system under control. The electronic control signals may be sent directly to an actuator (e.g., as in a choke valve) or indirectly (e.g., as in a VSD wherein the control signal may be converted to a power signal of the desired frequency by the VSD before being received by the motor). In some embodiments, a determination is made as to whether the constraints are feasible. If the operating constraints are not feasible, the nominal control action (e.g., from a reinforcement learning algorithm) is applied to the system under control (e.g., communicated to the one or more actuators 304). The system is then operated in accordance with the nominal control action.

### Experimental Results

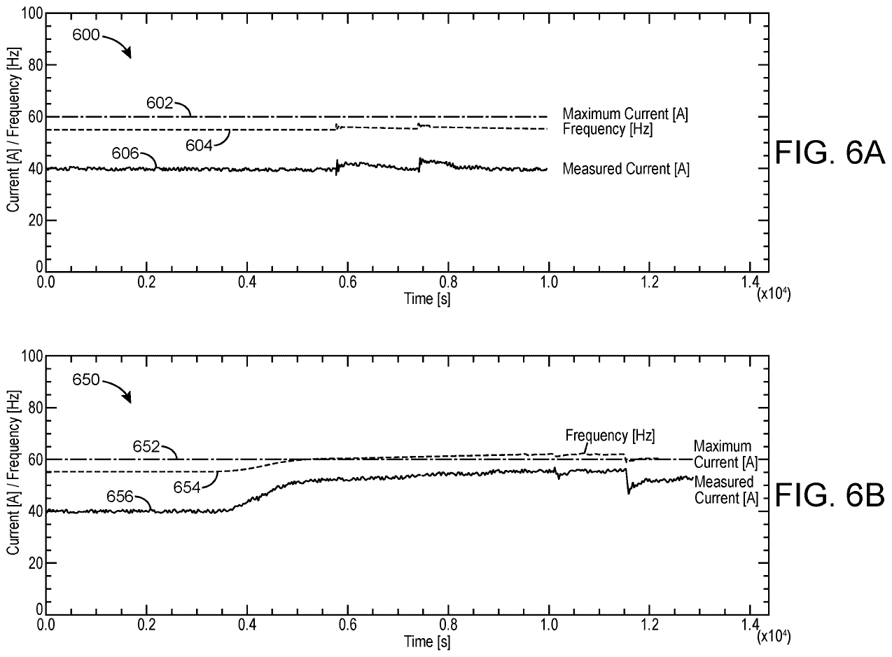

FIGS. 6A and 6B show experimental results of a control system implementing a fixed bounding parameter, a, and experimental results of a control system implementing a dynamically updated bounding parameter. FIGS. 6A and 6B demonstrate certain advantages of the systems and methods described herein when a dynamic bounding parameter is used. FIG. 6A shows plot 600 including experimental results with a fixed bounding parameter. The plot 600 shows a maximum current trace 602, a frequency trace 604, and a current trace 606 for the duration of an experiment of roughly 2.5 hours. During the experiment, the measured current stays a significant distance from the maximum allowable current, though operating at a higher current would lead to increased efficiency. Each time the current increases, it is pushed away from the maximum current with a behavior that may be indicative of conservative constraints and/or bounding parameter α. FIG. 6B shows plot 650 including experimental results with a dynamic bounding parameter. The plot 650 shows a maximum current trace 652, a frequency trace 654, and a current trace 656 for the duration of an experiment of roughly 3.5 hours. During the experiment with the dynamic bounding parameter the current trace 656 is shown to take advantage of increased flexibility provided by the dynamic value of the bounding parameter and the system operates closer to the maximum current of 60 A.

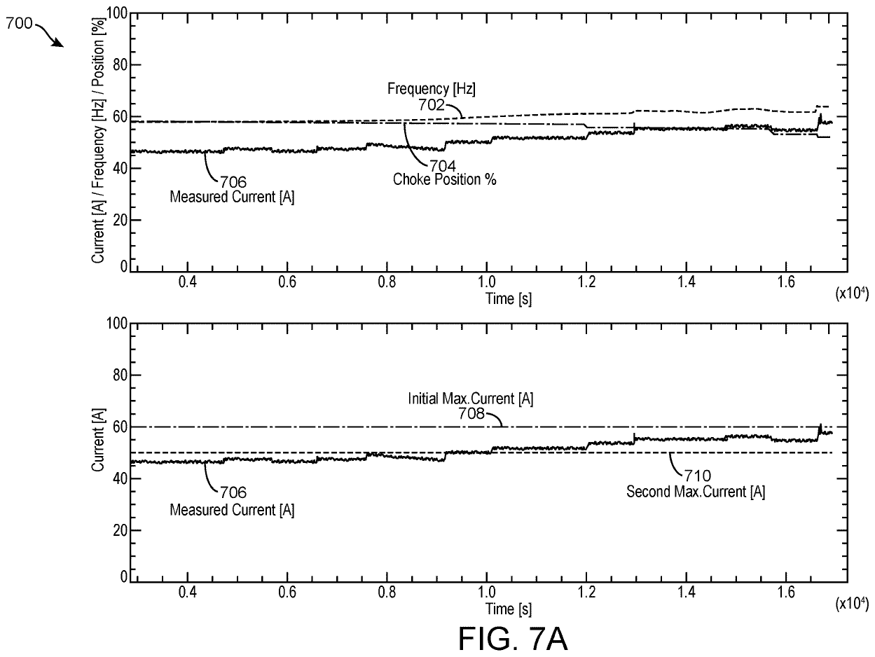

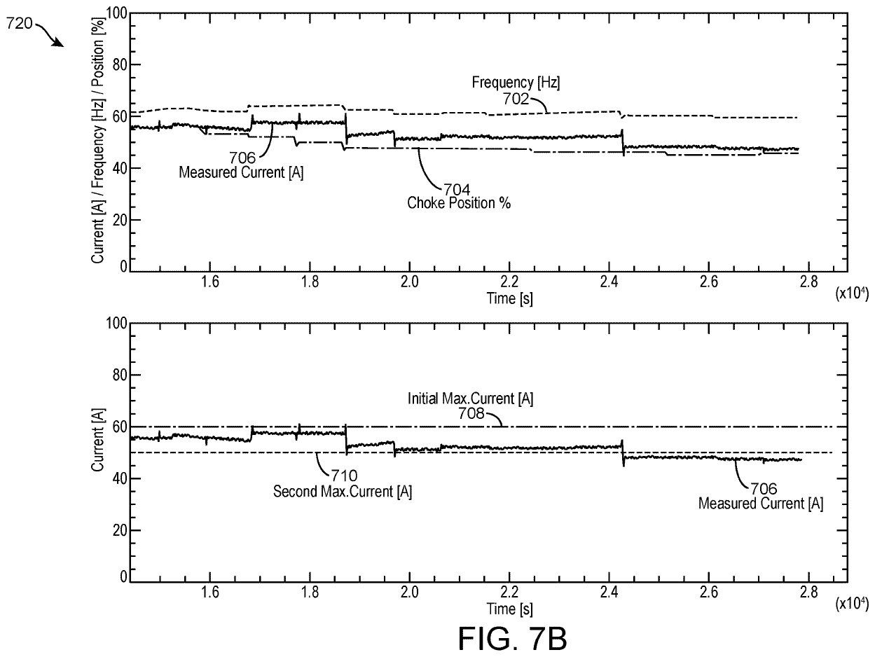

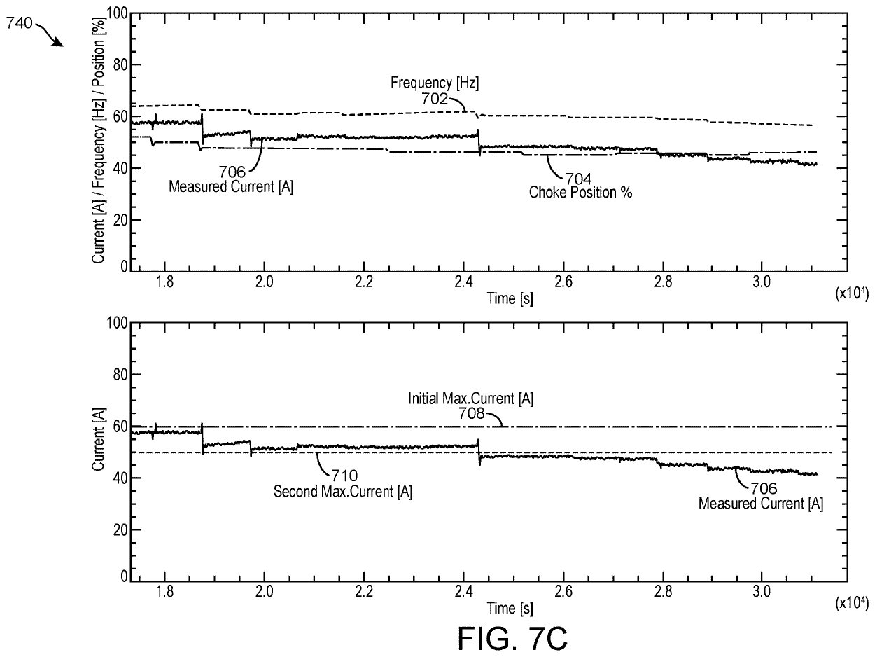

FIGS. 7A-7C show experimental results of the systems and methods described herein when a constraint is changed, causing the constraints of the barrier function generator 422 to become infeasible. Thus, FIGS. 7A-7C demonstrate certain advantages of the systems and methods described herein provided by the reinforcement learning trainer 412. For example, the reinforcement learning controller may use the dynamic bounding parameter to weight the reward in the to cause the reinforcement learning controller 418 to determine nominal control actions that drive the system being controlled towards the desired operating region even if the constraint-based control adjuster 424 cannot be used for a period of time due to infeasibilities. During the time the constrains are infeasible the nominal control action was passed to the controlled system and the reinforcement learning algorithm drives the system towards the desired operating region until the constraint-based control adjuster can begin adjusting the actions again. FIGS. 7A-7C show the same experiment for different time periods. A plot 700 of FIG. 7A shows a frequency trace 702, a choke position trace 704, a current trace 706, an initial maximum current trace 708, and a second maximum current trace 710 for experimental times between 3000 and 17000 seconds. The maximum current is decreased from 60 A as shown by the initial maximum current trace 708 to 50 A as shown by the second maximum current trace 710 at around 18500 s.

The current trace 706 was increasing towards the initial maximum current trace 708 at the time the maximum current was decreased. At this time, the measured current is in violation of the maximum current constraint and the constraints of the constraint-based control adjuster 424 may have become infeasible. Plot 720 of FIG. 7B shows the same experiment for the time period of 15000 seconds to 28000 seconds, and a plot 740 of FIG. 7C shows the time period of 17500 seconds to 31000 seconds. After the maximum current has been decreased, the current is show to be driven towards a value below the 50 A bound. This demonstrates the capability of the reinforcement learning controller 418 to drive the operating point back towards the desired region even when the constraints of the constraint-based control adjuster 424 become infeasible.

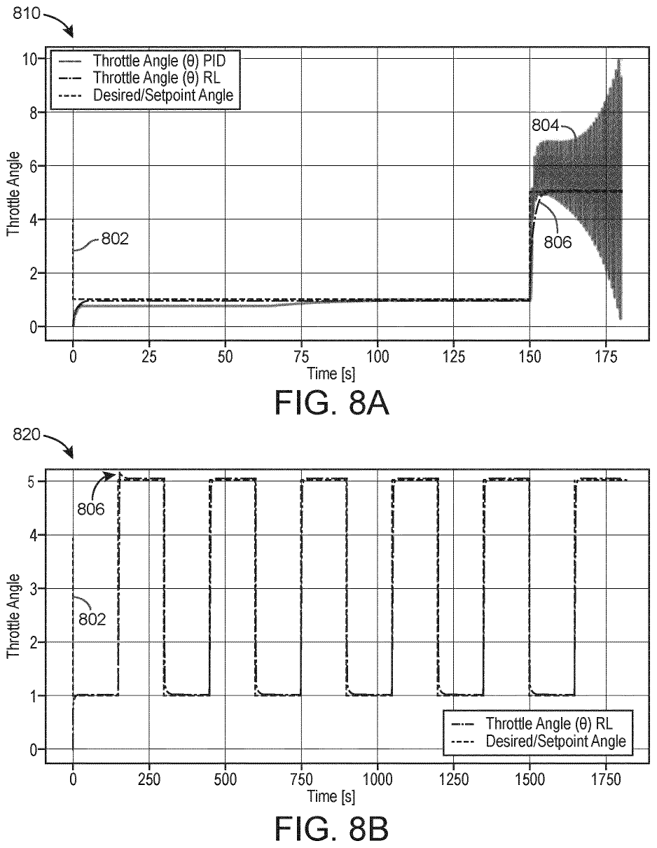

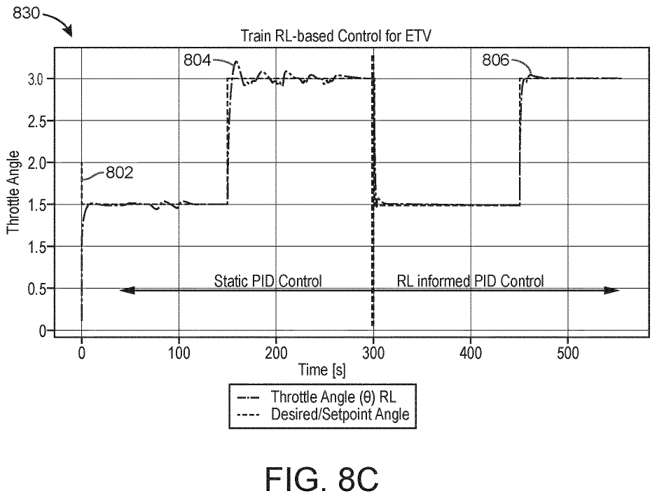

FIGS. 8A-8C show experimental results for an electric throttle system. The throttle system includes a DC drive (e.g., powered by a chopper), a gearbox, a valve plate, a dual return spring, and a position sensor. The control is configured to provide setpoint tracking of the throttle angle with desired performance (e.g., in terms of setpoint tracking, disturbance rejection, change in system dynamics, nonlinearity) and satisfy constraints in terms of the operating point such as any state and/or control action. For example, constraints may be provided on the overshoot in response and physical limits on motor current, motor torque, angular position, or velocity.

The experimental configuration used to generate the results of FIGS. 8A-8C may follow the configuration shown in FIG. 4B. For example, the experimental configuration includes a feedback controller 364 configured as a PID controller. The feedback controller 364 may be configured to calculate an error eₜ=θ_{desired}−θₜ between the desired (e.g., setpoint) throttle angle and the measured throttle angle and generate a control action to drive the throttle angle towards the setpoint according to the PID equations. In addition, the site controller 400 is configured to provide control parameters K_{P}, K_{I}, and K_{D}, to the feedback controller 364 that is configured to cause the feedback controller 364 to generate a control output that satisfies the constraints.

The dynamic behavior of the throttle system can be described using,

$${L}_{a} \frac{{di}_{a}}{dt} + {R}_{a} {i}_{a} = {k}_{ch} u - {k}_{v} {ω}_{m} ,$$

$${τ}_{app} = {k}_{t} {i}_{a} - {τ}_{s} - {τ}_{L} ,$$

$$J \frac{d {ω}_{m}}{dt} = {τ}_{app} - {τ}_{F} ,$$

$$\frac{d θ}{dt} = {k}_{v} {ω}_{l} ,$$

$$and$$

$$\frac{d {τ}_{F}}{dt} = {k}_{F} ( ( {ω}_{m} - \frac{{ω}_{m}}{\vert {M}_{c} \vert} ) {τ}_{F} ) ,$$

where u is the input control voltage, k_{ch} denotes chopper gain, iₐ represents the DC motor armature current, τₛ is the return spring torque, τ_{L} denotes the load (disturbance) torque, τₐₚₚ represents the so-called applied torque, M_{c} is the Coulomb friction, τ_{F} denotes the friction torque, ωₘ represents the motor angular velocity, θ is the position of the throttle plate, Rₐ denotes the overall resistance of the armature circuit, Lₐ represents the overall armature inductance, kₜ and kₛ are the motor torque and spring torque constants, kᵥ denotes the electromotive force constant, kₗ represents the gear ratio, and J is the overall moment of inertia referred to the motor side.

In the experimental configuration for FIGS. 8A-C, the proximity of the operating point to the desired target is used as a reward function, the proximity to the constraints is used as a penalty, and the barrier function may include (e.g., encode) the kth percentage of desired target as overshoot as in,

$$h ( {θ}_{t} ) = ‖ {θ}_{desired} - {θ}_{t} ‖ - k ‖ {θ}_{desired} ‖$$

The reinforcement learning controller 418 generates nominal control parameters K_{P}, K_{I}, and K_{D} and provides the control parameters to the constraint-based control adjuster 424, where they can be adjusted to ensure the desired behavior based on the constraints from the barrier function generator 422.

FIG. 8A shows plot 810 of experimental results for the experimental configuration. The results compare proportional integral derivative (PID) control (e.g., using static control parameters) to the reinforcement learning informed control described herein. The plot 810 is illustrative of a setpoint change. At time 150 s, the setpoint 802 is increased from approximately 1 to 5. The throttle angle as controlled by a static PID controller 804 is shown to become unstable and include many oscillations. The behavior may be related to the nonlinear dynamics of the throttle control (e.g., PID parameters for a first setpoint may not perform well at a second setpoint). The throttle angle as controlled by the reinforcement learning informed control 806 is shown to track the setpoint, illustrating at least some of the advantages of the site controller 400.

FIG. 8B shows plot 820 of experimental results for the experimental configuration. The results show the adaptive behavior of reinforcement learning informed control described herein. As the setpoint 802 is changed multiple times, the site controller 400 learns improved PID control parameters for the given states and further limits overshoot of the throttle angle as controlled by the reinforcement learning informed control 806.

FIG. 8C shows plot 830 of experimental results for the experimental configuration, illustrating a switch from static PID control to PID control informed by reinforcement learning, according to some embodiments. Control was changed from a static PID to a reinforcement learning informed control at time 300 s (illustrated by the bold vertical broken line). The parameter of the barrier function, k, was configured to 0.001 for the control barrier function to limit overshoot. The throttle angle as controlled by a static PID controller 804 (e.g., the first 300 s) is shown to have significant overshoot and violate the desired overshoot constraint defined by k. The throttle angle as controlled by the reinforcement-learning-informed control 806 (e.g., after 300 s) is shown to have minimal overshoot, thereby illustrating some advantages of the systems and methods described herein, for example, ensuring the parameters used by the feedback controller 364 provide desired behavior and/or satisfy certain constraints.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (i.e., permanent or fixed) or moveable (i.e., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for controlling a hydrocarbon extraction site, the system comprising:
one or more processing circuits configured to:
calculate a bounding parameter based on a distance between an operating point and a boundary of a desired operating region;
generate a nominal control action for the hydrocarbon extraction site based on a reinforcement learning model;
generate one or more operating constraints based on the bounding parameter; and
determine an implemented control action that (i) satisfies the one or more operating constraints and (ii) is based on the nominal control action, wherein the hydrocarbon extraction site is operated in accordance with the implemented control action.

2. The system of claim 1, wherein the one or more processing circuits are configured to determine the implemented control action by:
determining implemented parameters for a control algorithm configured to cause the implemented control action to satisfy the one or more operating constraints; and
calculating the implemented control action according to the control algorithm using the implemented parameters.

3. The system of claim 1, wherein the one or more processing circuits are configured to generate the nominal control action based on the reinforcement learning model by:
generating nominal parameters for a control algorithm according to the reinforcement learning model; and
calculating the nominal control action according to the control algorithm using the nominal parameters.

4. The system of claim 1, wherein the operating point comprises at least one of:
a current of a motor;
a choke position of a valve;
an effective flow coefficient of the valve;
a voltage of the motor;
a frequency of an electrical signal applied to the motor;
a speed of the motor;
a fluid pressure;
a fluid flow;
a fluid temperature; or
a relay state.

5. The system of claim 1, wherein the reinforcement learning model is trained with a reward function comprising a performance term and a penalty term.

6. The system of claim 5, wherein a weight of the performance term and a weight of the penalty term are based on the bounding parameter.

7. The system of claim 6, wherein the weight of the performance term is a nonincreasing function of the bounding parameter and the weight of the penalty term is a nondecreasing function of the bounding parameter.

8. The system of claim 1, wherein the one or more processing circuits are configured to determine whether the one or more operating constraints are infeasible, and wherein the hydrocarbon extraction site is operated in accordance with the nominal control action responsive to a determination that the one or more operating constraints are infeasible.

9. The system of claim 1, wherein the one or more processing circuits are configured to determine the implemented control action by:
calculating a distance between a candidate control action and the nominal control action; and
selecting the candidate control action based on the distance.

10. A system for controlling a hydrocarbon extraction site, the system comprising one or more processing circuits configured to:
calculate a bounding parameter based on a distance between an operating point and a boundary of a desired operating region;
generate, using a machine learning model, one or more nominal control parameters for a control algorithm configured to control a variable of the hydrocarbon extraction site according to a setpoint;
generate one or more operating constraints for one or more implemented control parameters based on the bounding parameter, the one or more operating constraints configured to constrain a control action generated according to the control algorithm using the one or more implemented control parameters to maintain the variable within the desired operating region; and
determine the one or more implemented control parameters that (i) satisfy the one or more operating constraints and (ii) are based on the one or more nominal control parameters, wherein the hydrocarbon extraction site is operated in accordance with the one or more implemented control parameters.

11. The system of claim 10, wherein the one or more processing circuits are configured to communicate the implemented control parameters to a second device configured to generate an implemented control action based on the one or more implemented control parameters to operate the hydrocarbon extraction site in accordance with the control algorithm using the one or more implemented control parameters.

12. The system of claim 10, wherein the operating point comprises at least one of:
a current of a motor;
a choke position of a valve;
an effective flow coefficient of the valve;
a voltage of the motor;
a frequency of an electrical signal applied to the motor;
a speed of the motor;
a fluid pressure;
a fluid flow;
a fluid temperature; or
a relay state.

13. The system of claim 10, wherein the machine learning model is a reinforcement learning model trained with a reward function comprising a performance term and a penalty term.

14. The system of claim 13, wherein a weight of the performance term is a nonincreasing function of the bounding parameter and a weight of the penalty term is a nondecreasing function of the bounding parameter.

15. The system of claim 10, wherein the one or more processing circuits are configured to determine whether the one or more operating constraints are infeasible, and wherein the hydrocarbon extraction site is operated in accordance with the one or more nominal control parameters responsive to a determination that the one or more operating constraints are infeasible.

16. The system of claim 10, wherein the one or more processing circuits are configured to determine the one or more implemented control parameters by:
calculating a distance between candidates for the one or more implemented control parameters and the one or more nominal control parameters; and
selecting the one or more implemented control parameters from the candidates based on the distance.

17. A system for controlling a hydrocarbon extraction site, the system comprising one or more processing circuits configured to:
calculate a bounding parameter based on a distance between an operating point and a boundary of a desired operating region;
generate, using a reinforcement learning model, one or more nominal control parameters for a control algorithm configured to control a variable of the hydrocarbon extraction site according to a setpoint;
generate a nominal control action by executing the control algorithm using the one or more nominal control parameters;
generate one or more operating constraints for an implemented control action based on the bounding parameter, the one or more operating constraints configured to constrain the implemented control action to maintain the variable within the desired operating region; and
determine the implemented control action that (i) satisfies the one or more operating constraints and (ii) is based on the nominal control action, wherein the hydrocarbon extraction site is operated in accordance with the implemented control action.

18. The system of claim 17, wherein:
the one or more processing circuits are disposed on a first device and a second device;
the first device is configured to generate the one or more nominal control parameters and the one or more operating constraints; and
the second device is configured to:
determine the implemented control action that (i) satisfies the one or more operating constraints and (ii) is based on the nominal control action; and
operate the hydrocarbon extraction site in accordance with the implemented control action.

19. The system of claim 18, wherein the first device is a server device and the second device is an edge device.

20. The system of claim 17, wherein the reinforcement learning model is trained with a reward function comprising a performance term and a penalty term.
